(19) United States
(12) Patent Application Publication
(10) Pub. No.: US 2006/0066910 A1
(43) Pub. Date: Mar. 30, 2006

(54) Image forming apparatus, image forming method, and recording medium

(76) Inventor: Kei Yasutomi, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/231,928

(22) Filed: Sep. 22, 2005

(30) Foreign Application Priority Data
Sep. 30, 2004 (JP) 2004-285757

(51) Int. Cl. H04N 1/405

(52) U.S. Cl. 358/3.13

(57) ABSTRACT

An image forming apparatus is disclosed. A color moire score calculator selects a combination (a dither set) of four dither matrices from plural types of dither matrices stored in a dither matrix storage, and calculates color moire scores of secondary colors and tertiary colors. Dither processing is performed in a pseudo-halftoning part using a dither set having a preferable color moire score.

### BACKGROUND OF THE INVENTION

1. Field of the Invention

The present invention relates to an image forming apparatus for performing pseudo halftoning using a dither method, an image forming method, and a recording medium.

2. Description of the Related Art

Image data that are input into image forming apparatuses include, in the case of a gray-scale image such as a photograph, multivalued data having 8 through 12 bits per pixel. However, in image forming apparatuses (including electrophotographic systems) that form images (so-called hard copy) on paper, available gray levels per pixel are in fact very limited. In order to solve this problem, hard copy apparatuses apply higher resolution, such as 600 dpi and 1,200 dpi, so as to modulate the image intensity by using plural pixels according to an area modulation scheme, thereby representing halftone images in a pseudo manner. Such a processing of converting input image data into a pseudo halftone image is known as pseudo halftoning.

The present invention relates to an image forming apparatus that performs a dither method, which is one a method for performing pseudo halftoning, and relates to a combination of dither matrices (a combination of the number of screen lines and the screen angle of plural dither matrices) applied to full-color images.

As quantization processing of multivalued image data according to the dither method has been known in the art and disclosed in, for example, Non-Patent Document 1, details thereof are omitted. A dithered image has a periodic structure. A color image is formed by superposing plural toner images (usually, by four colors of cyan (C), magenta (M), yellow (Y), and black (K)).

Images of theses four colors are dithered in different manners, so that the toner images have different periodic structures. Although there have been methods for dithering images of the four colors to have the same periodic structure, these types of methods are less used today because the colors are more likely to vary due to variation of positions where the colors are superposed. A method is now used widely that prevents such a color variation problem by generating images of the four colors that have different periodic structures (that sets different screen angles and different number of screen lines for the images). This method, which has been commonly used in the field of printing, is used more and more also in the field of hard copy, such as electrophotography, in addition to the field of printing.

When toner images having different periodic structures are superposed, an interference pattern called beat, which is like the one that can be seen when waves are superposed, is sometimes observed. If this interference pattern which is also called color moire appears in a low-frequency band (i.e., if the beat has a low frequency) and is visually perceived, users may notice a reduction in image quality due to the interference pattern.

In general, when determining matrices used in dithering of the four colors, a combination of matrices capable of minimizing color moire that occurs as a result of superposition of images of the four colors is selected. However, because techniques for balancing all of the color moire that occur in different colors are not established, combinations that are considered preferable from experience have been used widely.

A combination of dither matrices of the four colors may be arranged in a manner as shown in FIGS. 12 and 13 which is commonly employed in industrial printers. In this arrangement, the screen angle of Y is set to 0 degrees; the screen angle of C is set to 15 degrees; the screen angle of K is set to 45 degrees; and the screen angle of M is set to 75 degrees. C, M, Y and K have substantially the same number of screen lines of about 175 lpi, although there is no specific restriction applied to the number.

A resolution of 2,400 dpi or higher is required for realizing these screen angles exactly. If the resolution is less than that, available screen angles that are close to the above screen angles are selected. FIG. 13 shows screens arranged in the above-described manner at a resolution of 2,400 dpi. In this arrangement, because the periodic structure has a square shape and a dot screen is employed, a directional axis has an equivalent directional axis at a position rotated 90 degrees with respect to the screen angle of each color. In this combination, taking advantage of the fact that the color moire that occurs between Y and C, M is less apparent, the screen angle of Y is 15 degrees apart from the screen angles of C and M. In the field of printing, it is said that the color moire that occurs between Y and other colors of C, M, and K is less apparent.

A method for eliminating color moire that occurs due to superposition of toner images of different colors having such a periodic structure is disclosed in, for example, Patent Documents 1 and 2.

[Non-Patent Document 1]Electrophotography—The Society Journal—, Vol. 24, No. 1, pp. 51-59 (1985)

[Patent Document 1] Japanese Patent Laid-Open Publication No. 2002-112047

[Patent Document 2] Japanese Patent Laid-Open Publication No. 2003-296731

The dither matrix is classified, roughly, into (1) a dot concentration type (dot screen), (2) a Bayer type, and (3) a line type (line screen). The present invention relates to a method of combining plural dither matrices of the line type of (3) for creating a color image.

Line type dither matrices have the following advantages compared to dot concentration type dither matrices. In dot concentration type dither matrices, because a growth center needs to have a square periodic structure, the number of screen lines and the screen angle available are limited. On the other hand, in the line type dither matrices, because there is no difference between a growth center having a rectangular or parallelogram periodic structure and a growth center having a square periodic structure, combinations (choices) of the number of screen lines and the screen angles available for dither matrices are dramatically increased.

The line type dither matrices are also advantageous in forming color images by superposing different color patterns. Because an interference pattern called color moire appears when colors are superposed, the color patterns are arranged to have different screen angles. In view of color moire reduction, it is preferable in full-color images to set screen angles of the four colors of CMYK at different screen angles to increase angle differences as much as possible. In dot concentration type dither matrices, directional axes (axes parallel to vectors representing periodic structures) of the four colors of CMYK need to be set within a range of 90 degrees (this is because directional axes are present in every 90 degrees in concentration type dither matrices).

In line screen dither matrices, on the other hand, because directional axes of the four colors of CMYK are allowed to be set within in a range of 180 degrees, CMYK patterns can have greater screen angle differences compared to the dot concentration type dither matrices. This makes it possible to produce images with reduced color moire.

However, because the line type dither matrices have the following problems, a combination of CMYK dither matrices (which is also referred to as a dither set) that is considered good based on experience has been in use.

The production process of line type dither matrices includes manual work requiring specialized skills, which make it difficult to produce all the dither matrices as desired. Even if more matrices become available, it is impractical to actually produce the available matrices and verify their effects in order to find a dither set with reduced color moire.

Also, even if line type dither matrices can be produced as desired by solving the above-described problem with dither matrix production, selecting a dither matrix set with reduced color moire is not easy. This is because there are several tens of thousands through billions of combinations of line screen dither matrices, i.e., dither matrix sets. It is very difficult to select a dither matrix set with reduced color moire from such numerous numbers of dither sets.

Outputting (printing out) images using all these combinations and verifying output images are almost impossible because of the large number of combinations. Color moire may be estimated not by outputting images, but by producing color image data and calculating spectrum data of images using FFT (Fast Fourier Transform). This method, however, requires a long calculation time because a large image area needs to be processed to detect intensity variation of color moire due to its low frequency. Therefore, it is almost impossible to perform such a calculation for all the numerous combinations.

Patent Document 2 discloses a color moire evaluation method. However, as an infinite series is included in a first-order Bessel function in the coefficient of Fourier series expansion used in this method, color moire evaluation by this method may require quite a long time. Therefore, it also seems to be almost impossible to perform such a calculation for all the dither sets.

According to study and image output experiments by the inventor of this invention, there are problems specific to line type dither matrices in determination of a dither set having reduced moire, which are described below. The above-describe method of simply setting greater angle differences is not effective for color moire of tertiary colors (each of toner colors of C, M, Y and K is referred to as a primary color; a color created by mixing two of the toner colors is referred to as a secondary color, and a color created by mixing three of the toner colors is referred to as a tertiary color).

The problem specific to line dither matrices is color moire that occurs in tertiary colors. The color moire in tertiary colors is intensity/color variation at a low frequency that occurs only when toner images of three line type dither matrices are superposed. This type of color moire does not occur when two colors in three dither matrices are superposed. Therefore, prevention of occurrence of such tertiary color moire needs to be taken into consideration upon determination of a dither set of line type dither matrices. This makes selection of a dither set having reduced color moire more difficult.

The present invention provides conditions and a calculation method for combining line type dither matrices to produce a dither set that makes color moire hardly visible not only in secondary colors but also in tertiary colors unlike conventional dither matrices, and also provides a combination of dither matrices or a dither set having reduced color moire.

In some hard copy systems including electrophotographic systems, color moire that occurs between Y and CMK needs to be taken into account. The cause of occurrence of such color moire is unknown, but it is thought that the color moire related to Y appears because a Y toner affects CMK color development in some form in a process of heating and applying pressure to powder toners for fixing and developing colors in the electrophotographic systems.

Another possible cause is a mechanism as follows. When a color image is formed by an electrophotographic system, powder toner images are superposed. A resulting toner layer has a thickness of 20 μm-30 μm or greater, which is far greater than the thickness of an ink layer (1 μm-2 μm) formed by a non-electrophotographic system. Accordingly, there is a possibility that when such a thick toner layer is arranged in a screen form (dot screen, line screen) and superposed on a transfer body, toner images affect one another to cause moire. For example, in production of a red color image by superposition of an M pattern and a Y pattern, an M toner area ratio might be changed due to a presence of a Y toner (e.g. an M toner might release particles or be flattened during a transfer process to increase the M toner area ratio in an area where the Y toner is present). Such an influence of the Y pattern appears as a phenomenon specific to electrophotographic systems although the Y pattern itself does not contribute to occurrence of color moire.

Therefore, in electrophotographic systems, it is necessary to select a dither set that does not cause color moire including color moire that occurs between a Y pattern and other CMK patterns. In printing systems, unlike the electrophotographic systems, since color moire related to a Y pattern rarely occurs, only the prevention of color moire among CMK patterns is taken into account. That is, dot screens, which have little screen arrangement flexibility as described above, are not suitable for electrophotographic printing systems. Use of a dither set consisting of line screens, which have higher screen arrangement flexibility, can prevent the color moire related to a Y pattern.

From experiments performed by the inventor of this invention, it is found that the color moire that occurs between toner images of Y and other colors (CMK) varies depending on a production method of a toner. It was found that a toner produced by a polymerization method increases color moire related to Y compared to a toner produced by a milling method.

Production of a toner by the polymerization method has advantages such as easiness of reduction of volume-average particle diameter of toner, which largely affects image quality, and low energy consumption during toner production. Therefore, the polymerization method is becoming widely used in toner production in view of improvement of image quality and energy savings. However, it was found from the experiments performed by the inventor that a toner produced by the polymerization method increase moire as described above.

Although the cause of increase of moire due to the use of a toner produced by the polymerization method is unknown, the largest difference between the toner produced by the polymerization method and a toner produced by a milling method is that particles of the toner produced by the polymerization method are spherical. A toner containing spherical particles tends to release particles during a transfer process. Accordingly, when plural colors are superposed, it is possible that more particles are released so as to increase an area ratio change and increase moire related to Y.

It was also found from the experiments performed by the inventor that color moire between Y and CMK in the electrophotographic image forming apparatuses also depends on components contained in a toner. Color moire related to Y was observed to be more apparent when a toner containing a wax release agent was used compared to a toner not containing a wax release agent.

Electrophotographic image forming apparatuses that use a toner containing a wax release agent are advantageous in that there is no need to apply silicon oil to a heating roller in a fixing process and, therefore, maintenance of a fixing unit and supply of consumables are not required. However, color moire between Y and CMK is caused as described above.

### SUMMARY OF THE INVENTION

An embodiment of the present invention provides an image forming apparatus, an image forming method, and a recording medium to solve at least one problem described above. In a preferred embodiment, the present invention provides an image forming apparatus capable of outputting images while eliminating color moire that occurs between a Y pattern and CMK patterns as well as color moire that occurs among CMK patterns, an image forming method, and a recording medium.

According to an aspect of the present invention, there is provided an image forming apparatus that superposes color material images of four colors of cyan, magenta, yellow and black on a predetermined medium using color materials of the four colors, wherein each of the color material images of the four colors has a linear periodic structure represented by a function whose reflectance distribution formed by periodic adhesion of a corresponding color material is normalized at 1.0; when an intensity and a spatial frequency of a beat calculated by multiplication of each of combinations of spatial frequency components between the functions corresponding to two of the four colors are defined as P2i and f2i (suffix i identifying each of the combinations of the spatial frequency components between the two colors), respectively, a relational expression P2i·VTF(f2i)≦0.015 (VTF(f) representing a visual transfer function) is satisfied by each of six combinations of two colors selected from the four colors; and when the intensity and the spatial frequency of a beat calculated by multiplication of each of combinations of spatial frequency components among three functions corresponding to three of the four colors are defined as P3j and f3j (the suffix j identifying each of the combinations of the spatial frequency components among the three colors), respectively, a relational expression P3j·VTF(f3j)≦0.015 is satisfied by each of four combinations of three colors selected from the four colors.

### BRIEF DESCRIPTION OF THE DRAWINGS

FIG. 1 is a block diagram illustrating an image processing part according to the present invention;

FIG. 2 is a schematic diagram illustrating a first example of an image forming apparatus according to the present invention;

FIG. 3 is a diagram illustrating a relationship between a periodic structure and main/sub vectors and screen angle/lines;

FIG. 4 illustrates a periodic structure of a dither matrix of Embodiment 1;

FIG. 5 illustrates function forms of VTFs;

FIG. 6 illustrates a Fourier series expansion calculation model;

FIG. 7 is a flowchart for operations of calculating color moire scores;

FIG. 8 is a flowchart for operations of calculating color moire scores of a dither set;

FIGS. 9A and 9B illustrate dither periodic structures;

FIG. 10 is a schematic diagram illustrating a second example of an image forming apparatus according to the present invention;

FIG. 11 is a schematic diagram illustrating a third example of an image forming apparatus according to the present invention;

FIG. 12 is a diagram illustrating CMYK screen angle settings according to an electrophotographic printing system; and

FIG. 13 is a diagram illustrating a dot screen periodic structure (2400 dpi) according to an electrophotographic printing system.

### DETAILED DESCRIPTION OF THE PREFERRED EMBODIMENT

The following description provides exemplary embodiments of the present invention with reference to the accompanying drawings.

### Embodiment 1

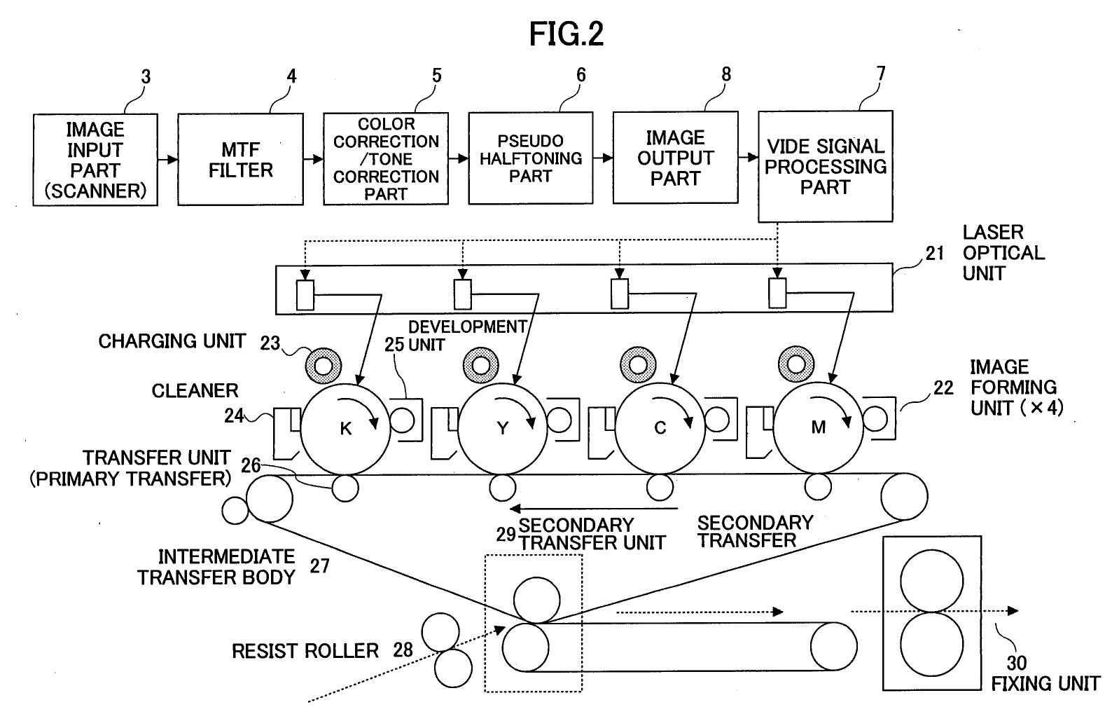

FIG. 2 is a schematic diagram illustrating an image forming apparatus according to the present invention. The image forming apparatus of FIG. 2 is a full-color image forming apparatus that forms an image by superposing color component images of four colors of cyan (C), magenta (M), yellow (Y), and black (K) onto a recording sheet. According to Embodiment 1, four image forming units 22 corresponding to color components of C, M, Y, and K are arranged as shown in FIG. 2. Color component images formed by the image forming units 22 are sequentially transferred onto an intermediate transfer body (intermediate transfer belt) 27 arranged in contact with the four image forming units 22. The intermediate transfer body 27 is rotated by a not-shown drive unit (motor or gear) at predetermined timings such that the color component images are superposed at predetermined positions on the intermediate transfer body 27. The color component images superposed on the intermediate transfer body 27 are all transferred to the recording sheet to form superposed images on the recording sheet.

According to Embodiment 1, the color image forming units 22 each includes a photoreceptor drum, a charging unit 23 that charges the photoreceptor drum to a desired voltage, a laser optical unit 21 that writes output image data (pseudo-halftoned image data) onto the charged photoreceptor drum so as to form an electrostatic latent image, a development unit 25 that develops the electrostatic latent image formed on the photoreceptor drum using toner corresponding to the color component, a transfer unit 26 that transfers the toner image developed on by the development unit 25 from the photoreceptor drum onto the intermediate transfer body 27, and a cleaner 24 that cleans toner remaining on the photoreceptor drum, having not been transferred onto the intermediate transfer body 27.

The recording sheet, such as paper, is transported from a not-shown recording sheet bank (paper feed tray or a manual feed tray) by a transporting unit, and then transported to a secondary transfer unit 29 by a resist roller 28 at a predetermined timing. In the secondary transfer unit 29, the toner images (toner images of the four color components) formed on the intermediate transfer body 27 are transferred onto a predetermined position on the recording sheet. The recoding sheet on which the toner images are transferred is heated and pressed in a fixing unit 30 and ejected outside the apparatus.

The following describes the toner used in Embodiment 1. The toner used in Embodiment 1 is a polymerized toner prepared by the following method, and contains synthetic ester wax in toner components.

-Synthesis of Resin Particle Emulsion-

638 parts of ion-exchanged water, 11 parts of sodium salt of one-or-more-ethylene-oxide sulfate esters of methacrylic acid (Eleminol RS-30 from Sanyo Chemical Industries, Ltd.), 83 parts of styrene, 83 parts of methacrylic acid, 110 parts of butyl acrylate, and 1 part of ammonium persulfate were placed in a reaction vessel having a stirring rod and a thermometer, and were stirred at 400 rpm for 15 minutes to obtain a white emulsion. The temperature inside the reaction vessel was elevated to 80° C. by heating, and the emulsion was reacted for 5 hours. Thirty (30) parts of aqueous solution of 1% ammonium persulfate were added into the emulsion, and the emulsion was aged at 80° C. for 7 hours to obtain an aqueous dispersion liquid fine particle dispersion liquid 1 containing a vinyl resin (quaterpolymer of styrene-methacrylic acid-butyl acrylate-sodium salt of one-or-more-ethylene-oxide sulfate esters of methacrylic acid). The volume-average particle diameter of fine particles of the fine particle dispersion liquid 1 measured by a particle size distribution analyzer LA-920 (Horiba, Ltd.) was 0.09 μm. A portion of the fine particle dispersion liquid 1 was dried to isolate a resin content. The obtained resin content had a Tg of 58° C.

-Adjustment of Aqueous Phase-

1,000 parts of ion-exchanged water, 83 of parts of the fine particle dispersion liquid 1, 37 parts of aqueous solution of 48.5% dodecyl diphenylether disulfonic acid disodium salt (Eleminol MON-7 from Sanyo Chemical Industries, Ltd.), and 90 parts of ethyl acetate were mixed and stirred to obtain a white emulsion (referred to as aqueous phase 1).

-Synthesis of Low-Molecular Polyester-

229 parts of an adduct containing 2 mol of bisphenol A ethylene oxide, 529 parts of an adduct containing 3 mol of bisphenol A propylene oxide, 208 parts of terephthalic acid, 46 parts of adipic acid, and 2 parts of dibutylethylene oxide were placed in a reaction vessel having a cooling pipe, a stirrer, and a nitrogen-introducing pipe, and were reacted at 230° C. for 8 hours under normal pressure. 44 parts of trimellitic anhydride were then added to the reaction vessel, and the mixture was reacted at 180° C. for 2 hours under normal pressure to obtain low-molecular polyester 1. The low-molecular polyester 1 had a number-average molecular weight of 2,500, a weight-average molecular weight of 6,700, and a Tg of 43° C.

-Synthesis of Prepolymer Having an Isocyanate Group-

682 parts of an adduct containing 2 mol of bisphenol A ethylene oxide, 81 parts of 2 mol bisphenol A propylene oxide, 283 parts of terephthalic acid, 22 parts of trimellitic anhydride, and 2 parts of dibutylethylene oxide were placed in a reaction vessel having a cooling pipe, a stirrer, and a nitrogen-introducing pipe, and were reacted at 230° C. for 8 hours under normal pressure. Then, a resulting mixture was further reacted for 5 hours under a reduced pressure of 10-15 mm Hg to obtain intermediate polyester 1. The intermediate polyester 1 had a number-average molecular weight of 2,100, a weight-average molecular weight of 9,500, a Tg of 55° C., an acid number of 0.5, and a hydroxyl value of 51.

Then, 410 parts of the intermediate polyester 1, 89 parts of isophorone diisocyanate, and 500 parts of ethyl acetate were placed in a reaction vessel having a cooling pipe, a stirrer, and a nitrogen-introducing pipe, and were reacted at 100° C. for 5 hours to obtain prepolymer 1. The prepolymer 1 had 1.53% by weight of free isocyanate.

-Synthesis of Ketimine-

170 parts of isophorone diamine and 75 parts of ethyl methyl ketone were placed in a reaction vessel having a stirring rod and a thermometer, and were reacted at 50° C. for 5 hours to obtain a ketimine compound 1. The ketimine compound 1 had an amine value of 418.

-Adjustment of Master Batch Pigment-

1,200 parts of water, 540 parts of carbon black (Printex 60 from Degussa Ltd.), 1,200 parts of the low-molecular polyester 1 were mixed in a Henshel Mixer (Mitsui Mining Co., Ltd.). After kneading at 130° C. for 45 minutes, a resulting mixture was extended and cooled through two rollers. Then, the mixture was ground by a pulverizer into pieces of length 1 mm or smaller to obtain master batch 1.

-Preparation of Oil Phase-

378 parts of the low-molecular polyester 1, 110 parts of synthetic ester wax, 22 parts of charge controlling agent (salicylic acid metal complex E-84 from Orient Chemical Industries Co., Ltd.), and 947 parts of ethyl acetate were placed in a reaction vessel having a stirring rod and a thermometer. They were stirred while being heated to 80° C. After maintaining a resulting mixture at 80° C. for 5 hours, the mixture was cooled to 30° C. in an hour. Then, 500 parts of the master batch 1 and 500 parts of ethyl acetate were added to the mixture and mixed for 1 hour to obtain material solution 1.

1,324 parts of the material solution 1 were placed into another vessel, and carbon black and wax contained therein were dispersed by a beads mill (Ultra Visco Mill from Imecs Co., Ltd.) filled with zirconia beads having a diameter of 0.5 mm by 80 volume % under a condition of a liquid feeding speed of 1 kg/hour and a disk peripheral speed of 6 m/second for three passes. Then, 1,324 parts of solution of 65% ethyl acetate of the low-molecular polyester 1 were added, and a resulting mixture was milled for one pass by the beads mill under the same conditions as described above to obtain pigment and wax dispersion liquid 1. The pigment and wax dispersion liquid 1 had a solid concentration of 50% (130° C., 30 minutes).

-Emulsification and De-Solvent-

650 parts of the pigment and wax dispersion liquid 1, 140 parts of the prepolymer 1, and 6.0 parts of the ketimine compound 1 were placed in a vessel and mixed by a TK homomixer (Tokushu Kika Kogyo Co., Ltd.) at 5,000 rpm for 1 minute. Then, 1,200 parts of the aqueous phase 1 were added to the vessel, and mixed by the TK homomixer at 13,000 rpm for 20 minutes to obtain emulsified slurry 1.

The emulsified slurry 1 was placed in a vessel having a stirrer and a thermometer to remove a solvent therefrom at 30° C. for 8 hours. Then, the slurry was aged at 40° C. for 8 hours to obtain a dispersion slurry 1.

-Wash and Dry-

After 100 parts of the dispersion slurry 1 were filtered under a reduced pressure,

(1): 100 parts of ion-exchanged water were added to a filtered cake to be mixed by the TK homomixer at 12,000 rpm for 10 minutes, and a resulting mixture was filtered.

(2): 100 parts of an aqueous solution of 10% sodium hydrate were added to the filtered cake of (1) to be mixed by the TK homomixer at 12,000 rpm for 30 minutes, and the resulting mixture was filtered under a reduced pressure.

(3): 100 parts of 10% hydrochloric acid were added to the filtered cake of (2) to be mixed by the TK homomixer at 12,000 rpm for 10 minutes, and the resulting mixture was filtered.

(4): 300 parts of ion-exchanged water were added to the filtered cake of (3) to be mixed by the TK homomixer at 12,000 rpm for 10 minutes, and the resulting mixture was filtered. This operation was repeated again to obtain a filtered cake 1. The filtered cake 1 was dried by an air drier at 45° C. for 48 hours, and was sieved by a 75 μm mesh. Then, 0.5 parts of hydrophobic silica (surface-treated with hexamethyl disilazane, specific surface area: 200 m2/g) and 0.5 parts of hydrophobic rutile type titanium oxide (surface-treated with Isobutyl trimethoxysilane, average primary particle diameter: 0.02 μm) were mixed with 100 parts of toner particles (filtered cake 1) by a Henshel mixer to obtain a toner A. The Toner A had a volume-average particle diameter of 5.43 μm, a Tg of 46° C., and a THF insoluble matter of 12% in resin component.

The particle diameter of the toner prepared by the above described method was measured by a particle size measuring machine “Coulter Counter TA II” (from Coulter Electronics Ltd.) of which aperture diameter is set to 100 μm. A volume-average particle size and a number-average particle size were detected by this particle size measuring machine. The volume-average particle size of the toner prepared in Embodiment 1 was 5.5 μm. The ratio of the pigment contained in the toner relative to the resin was 6.0%. Cyan, magenta, and yellow toners were prepared in the same manner.

Although the toner preparation method is described above, materials used for preparing the toner are not limited thereto. Especially, material to be contained in the toner as a wax release agent is not limited to a synthetic ester wax and may include, for example, carnauba wax, montan wax, and oxidized rice wax. The method for preparing the toner of the present invention is not limited to the above-described embodiment, and the toner may be prepared by other methods such as a dispersion polymerization method.

The following describes a flow of an image data input operation through an optical writing operation according to Embodiment 1. According to Embodiment 1, the laser optical unit 21 is configured to control pulse width modulation (PWD) based on output image data of respective color components and to perform optical modulation of a laser. Input image data go through a color correction and a tone correction by a color correction/tone correction (y correction) part 5, and go through a pseudo halftoning by a pseudo halftoning part 6. The pseudo halftoning is performed by a dither method, which is described below. The data processed in this way are sent as output image data to a video signal processing part 7.

The video signal processing part 7 receives the output image data, holds data elements corresponding to the number of luminous points in a line memory, and sends the data elements held in the line memory corresponding to pixels to a PWM control part at a predetermined timing (pixel clock) in accordance with signals synchronized with the rotation of a polygon mirror. The PWM control part converts the data elements into pulse width modulation (PWM) signals and sends them to a LD driver. The LD driver modulates and drives LD elements at a predetermined light intensity according to the PWM signals.

The light emitted from the LD is collimated by a collimator lens, and passes through an aperture to become a light beam having a desired beam diameter. The light beam transmitted through the aperture passes through a cylindrical lens so as to be incident on a polygon mirror. The light beam is reflected by the polygon mirror, collected by a scanning lens (f-θ lens), reflected by a reflection mirror, and focused on a photo receptor.

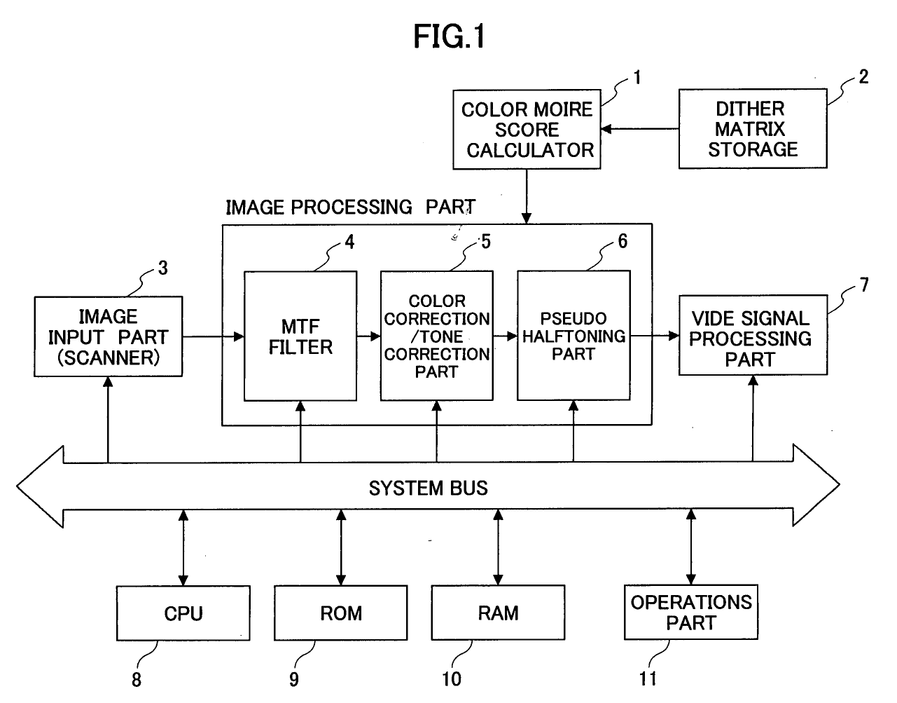

FIG. 1 is a block diagram illustrating an image processing part of the present invention. According to the present invention, the image processing part is formed by adding a color moire score calculator 1 and a dither matrix storage 2 to an existing image processing part. The dither matrix storage 2 stores plural types of dither matrices having different resolutions. The color moire score calculator 1 selects a combination (dither set) of four of the dither matrices stored in the dither matrix storage 2 and calculates color moire scores of secondary colors and tertiary colors. A dithering is performed in the pseudo halftoning part 6 using a dither set having preferable (low) color moire scores. These operations related to the present invention are described below in greater detail.

The image processing process for generating output image data based on input image data is as follows. Supposing that the input data are multivalued (8 bit) image data sent from a personal computer (comprising a CPU 8, a ROM 9, RAM 10, and an operations part 11), as the image forming apparatus of Embodiment 1 is a so-called laser printer type (in the case of digital copy machines, data are sent from scanners that are installed in the machines for reading originals).

In the image processing part, the input image data go through an enhancement processing by an MTF filter 4. The input image data further go through a color conversion from an RGB color space to a CMYK color space, and density control for representing predetermined tones by the color correction/tone correction (y correction) part 5. Then, the data are halftoned by the pseudo halftoning part 6 according to printer characteristics so as to be sent as output image data to an image output side (laser beam modulation drive side).

The MTF filtering, the color correction, and the y correction are well known in the art, and are not described herein.

The following describes a multivalued dither method for pseudo halftoning according to Embodiment 1. According to Embodiment 1, pseudo halftoned data are 4-bit (16-value) dithered data. In 4-bit dithering, 8-bit data (representing each pixel with 256 gray levels) are converted into output image data representing each pixel with 16 gray levels of level 0 through level 15. In this conversion, gray levels (256 levels) of individual pixels of the input image data are compared to thresholds preset to the above-described 16 levels so as to determine to which levels of 0 through 15 the individual pixels of the input data belong. That is, a 4-bit dither matrix comprises 15 matrices each having different thresholds. A method for calculating output image data using the dither method is disclosed in Japanese Patent Laid-Open Publication No. 2000-299783, and is not described herein.

Although the data are quantized into 4 bits (16 values) in Embodiment 1, the data may be quantized into, for example, 1 bit, 2 bits, and 8 bits without being limited to 4 bits. Regardless of the number of bits to be quantized, the same effects are obtained as long as a dither matrix for forming a toner image having a periodic structure is used.

The dither matrix according to Embodiment 1 is as follows. According to Embodiment 1, the dither matrix has a linear periodic structure, which is called a line screen dither matrix. The screen angle and the number of screen lines are often used to describe characteristics of dither matrices. The following therefore explains the screen angle and the number of screen lines of a line screen.

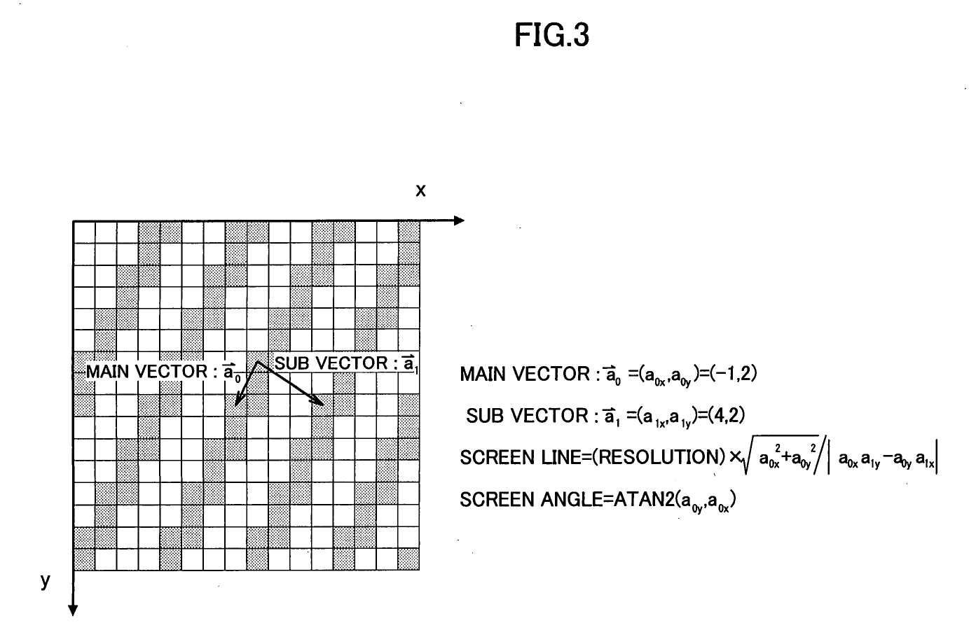

The screen angles and the number of screen lines of a dither matrix having a periodic structure shown in FIG. 3 is uniquely calculated by formulas shown in FIG. 3. It is generally convenient to represent a two-dimensional periodic structure with two vectors, which are hereinafter referred to as a main vector and a sub vector.

Table 21 shows a combination (dither set) of four dither matrices of Embodiment 1 using main vectors and sub vectors.

TABLE 21

| No. | Line [lpi] | Angle [deg.] | a0x | a0y | a1x | a1y |
|---|---|---|---|---|---|---|
| 0 | 150.0 | 0.0 | 1 | 0 | 0 | −4 |
| 1 | 150.0 | 90.0 | 0 | 1 | 4 | 0 |
| 2 | 212.1 | 45.0 | 1 | 1 | 2 | −2 |
| 3 | 212.1 | 135.0 | −1 | 1 | 2 | 2 |

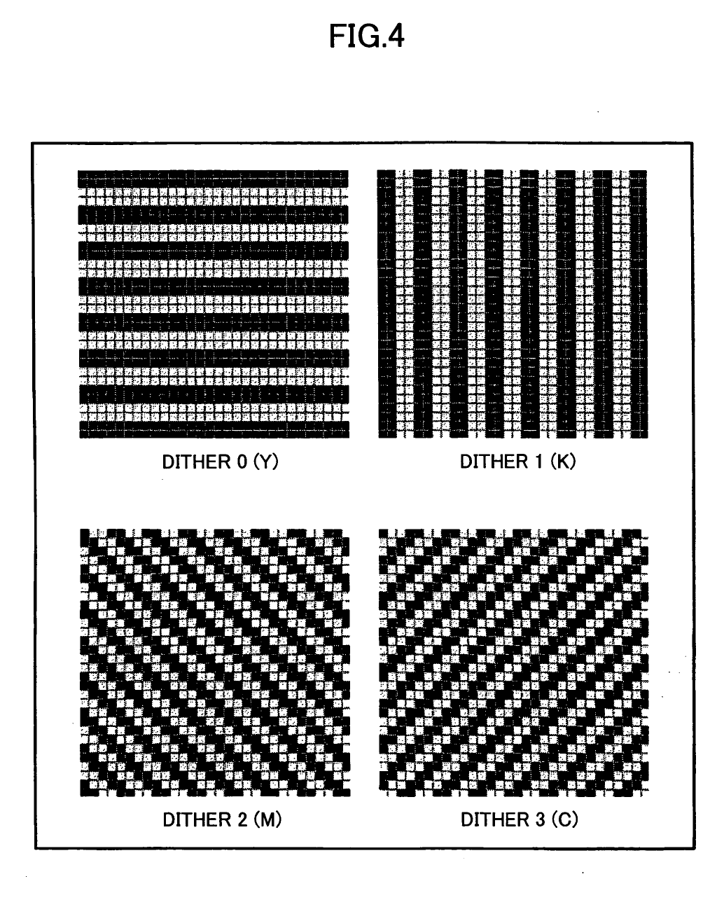

Periodic structures of these dither matrices are shown in FIG. 4.

According to Embodiment 1, the above-illustrated combination of dither matrices are applied to the four colors of CMYK. The dither set employed in Embodiment 1 is so formed that, in the case where reflectance distributions due to toner adhesion of each one of the four colors is represented by a function in which the reflectance of paper is set to 1.0 and the reflectance of the toner adhered area is represented by R, when an intensity and a spatial frequency of a beat calculated by multiplication of each of combinations of spatial frequency components between two functions corresponding to two of the four colors are defined as P2i and f2i (suffix i identifying each of the combinations of the spatial frequency components between the two colors), respectively, a conditional expression P2i·VTF(f2i)≦0.015 (VTF(f) representing a visual transfer function) is satisfied; and when the intensity and the spatial frequency of a beat calculated by multiplication of each of combinations of spatial frequency components among three functions corresponding to three of the four colors are defined as P3j and f3j (the suffix j identifying each of the combinations of the spatial frequency components among the three colors), respectively, a conditional expression P3j·VTF(f3j)≦0.015 is satisfied.

The maximum value among P2i·VTF(f2i) and P3j·VTF(f3j) is referred to as a color moire score. By setting the color moire score according to the above conditions, a toner image is formed in which color moires that occur due to contribution of all the frequency components including fundamental frequency components of CMYK are combined to be invisible. Therefore, even when an image is formed by superposing toner images of CMYK, color moire is not visually perceived. As a result, it becomes possible to improve image quality of a full-color image formed by superposing toner images of four colors of CMYK.

The following describes a method for calculating the color moire score according to the present invention. The color moire becomes invisible either when the spatial frequency of a beat generated by frequency components between two primary colors is high or because the amplitude of the beat is low. The color moire score is calculated by taking steps of (1) conversion to frequency components by Fourier series expansion, (2) derivation of beat amplitude by multiplication of two cosine waves, and addition of amplitudes having the same beat frequency, and (3) derivation of visual beat amplitude by multiplying the beat amplitude by a visual transfer (VTF). This calculation procedure is described below step by step.

All the frequency components containing fundamental frequency component primary colors are calculated as follows. Because a function (real valued even function) having a periodic structure represented by a main vector and a sub vector can be generally converted into frequency components by applying Fourier series expansion, this characteristic is utilized.

$$Periodic Function f ( \vec{r} ) = {T}_{00} + {\sum }_{k = 1}^{∞} {T}_{k0} cos [ k {{\vec{b}}_{0} \cdot \vec{r}}^{} ] + {\sum }_{l = 1}^{∞} {T}_{0 l} cos [ l {\vec{b}}_{1} \cdot \vec{r} ] + {\sum }_{ k = 1}^{∞} {\sum }_{l = 1}^{∞} \{ {T}_{kl} cos [ ( k \vec{{b}_{0}} + \vec{{lb}_{1}} ) \cdot \vec{{r}^{}} ] + {T}_{k - l} cos [ ( \vec{{kb}_{0}} - \vec{{lb}_{1}} ) \cdot \vec{r} ] \} \\ \begin{matrix}\vec{{b}_{0}} = 2 π ( \vec{{a}_{1}} \times \vec{{e}_{z}} ) / ( {\vec{{a}_{0}} \cdot ( \vec{{a}_{1}} \times \vec{{e}_{z}} ) )}^{} \\ \vec{{b}_{1}} = 2 π ( \vec{{e}_{z}} \times \vec{{a}_{0}} ) / ( {\vec{{a}_{0}} \cdot ( \vec{{a}_{1}} \times \vec{{e}_{z}} ) )}^{} \\ \end{matrix} \\ ( \vec{{e}_{z}} is a vector orthogonal to \vec{{a}_{0}} and \vec{{a}_{1}} , having a magnitude of 1 ) \qquad ( 1 )$$

The vector kb₀+lb₁ represents a spatial frequency vector, and the coefficient Tₖ₁ represents a component corresponding to this spatial frequency. The Tₖ₁ representing a spatial frequency component can be calculated, based on the original frequency function f(r), by the following formula:

$$Frequency Component {T}_{k1} = \frac{1}{S} {\int }_{cell} f ( \vec{r} ) cos [ ( \vec{{kb}_{0}} + \vec{{lb}_{1}} ) \cdot \vec{{r}^{}} ] ⅆ S \qquad ( 2 )$$

The integral of Formula (2) represents the surface integral of one period region, and S represents the area of one period region. This “one period region” corresponds to the area of a parallelogram formed by a main vector a0 and a sub vector a1.

As can be seen from Formulas (1) and (2), an arbitrary periodic function (real valued even function) can be represented by multiplication of cosine waves.

According to the present invention, since a toner image has a linear periodic structure as describe above, the coefficients of the second term and the forth term in Formula (1) are 0 (i.e., a toner image has a periodic structure only in a direction orthogonal to the main vector), Formula (1) is simplified as Formula (3):

$$Periodic Function f ( \vec{r} ) = {T}_{00} + {\sum }_{l = 1}^{∞} {T}_{0 l} cos [ l {{\vec{b}}_{1} \cdot \vec{r}}^{} ] \qquad ( 3 )$$

As the reflection density distribution of a dithered image has a linear periodic structure according to the present invention, an actual image can be related to the above-described Fourier series expansion by considering it as a periodic function.

The following describes a method for deriving the amplitude of a beat generated by superposition (multiplication) of two cosine waves. In the above described manner, another color (second color) can be converted into spatial frequency components, which include spatial frequency vectors different from the above one, by applying Fourier series expansion. The periodic structure of the second color is different from the above-described color (first color), and the main vector and the sub vector of the second color are c0 and c1, respectively. Therefore, the frequency vector of the second color is also different from the first color, and is represented as follows:

$$\begin{matrix}Periodic Function 2 g ( \vec{r} ) = {U}_{00} + {\sum }_{n = 1}^{∞} {U}_{0 n} cos [ \vec{{nd}_{1}} \cdot \vec{r} ] \\ \begin{matrix}\vec{{d}_{0}} = 2 π ( \vec{{c}_{1}} \times \vec{{e}_{z}} ) / ( {\vec{{c}_{0}} \cdot ( \vec{{c}_{1}} \times \vec{{e}_{z}} ) )}^{} \\ \vec{{d}_{1}} = 2 π ( \vec{{e}_{z}} \times \vec{{c}_{0}} ) / ( {\vec{{c}_{0}} \cdot ( \vec{{c}_{1}} \times \vec{{e}_{z}} ) )}^{} \\ \end{matrix} & ( 4 ) \\ ( \vec{{e}_{z}} is a vector orthogonal to \vec{{c}_{0}} and \vec{{c}_{1}} , having a magnitude of 1 ) & \end{matrix}$$

When cosine waves having slight different spatial frequencies are multiplied, a variation of amplitude in a low-frequency band called beat appears. The beat is expressed by the following Formula (5):

$$A cos ( \vec{{G}_{0}} \cdot \vec{r} ) \times B cos ( \vec{{G}_{1}} \cdot \vec{r} ) = ( 1 / 2 ) AB cos [ ( \vec{{G}_{0}} - \vec{{G}_{1}} ) \cdot \vec{r} ] + ( 1 / 2 ) AB cos [ ( \vec{{G}_{0}} + \vec{{G}_{1}} ) \cdot \vec{r} ] \qquad ( 5 )$$

The first term in Formula (5) represents a low-frequency variation that corresponds to a beat. On the other hand, the second term represents a high-frequency component, which may be ignored (i.e., which becomes 0 by being averaged as it is a high-frequency component). As can be appreciated from Formula (5), the beat amplitude is half of the product of the amplitudes of the superposed two cosine waves. The spatial frequency vector of the beat is the difference between the frequency vectors of the superposed two cosine waves. Accordingly, when there is a slight difference between frequency vectors of the cosine waves, a beat with the lowest spatial frequency (more visually apparent in a low frequency) or a color moire is observed.

If multiplication of Formulas (3) and (4) is performed, the first and the second colors have an infinite number of frequency components. However, since a term with a higher-order Fourier series expansion (i.e., a term in which the value of l and n are large) has a small expansion coefficient, only orders up to 3 through 5 are taken into consideration, and beats of terms with orders higher than that may be ignored. The following description is based on a case in which Fourier series expansion up to third-order expansion are performed.

A beat generated between two colors (periodic functions) may be any one of multiplication of all the cosine waves of l and n, the beat amplitude and the beat spatial frequency being calculated for all these combinations. For example, in the case of Fourier series expansion up to third order, there are combinations of l=1 through 3 as is clear from Formula (1), and three cosine waves with different spatial frequencies result from the expansion. In the same manner, n=1 through 3 are expanded to three cosine waves with different spatial frequencies according to Formula (2). Accordingly, there are 9 (=3×3) combinations of superpositions. The beat amplitude and the beat spatial frequency vector of each of the 9 combinations are calculated. For example, as for a product of a cosine wave having a spatial frequency vector of lb₁ and a cosine wave having a spatial frequency vector of nd₁, the spatial frequency vector of the beat is lb₁−(nd₁), and the beat amplitude is (½)·T₀₁·U₀ₙ. The suffix “i” used in the embodiments identifies these 9 combinations.

Similarly, as for a beat generated among three colors, multiplication of three cosine waves having different spatial frequencies is employed. The multiplication of three cosine waves can be expressed by the following Formula (6):

$$A cos ( \vec{{G}_{0}} \cdot \vec{r} ) \times B cos ( \vec{{G}_{1}} \cdot \vec{r} ) \times C cos ( \vec{{G}_{2}} \cdot \vec{r} ) = ( 1 / 4 ) ABC cos [ ( \vec{{G}_{0}} + \vec{{G}_{1}} + \vec{{G}_{2}} ) \cdot \vec{r} ] + ( 1 / 4 ) ABC cos [ ( \vec{{G}_{0}} + \vec{{G}_{1}} - \vec{{G}_{2}} ) \cdot \vec{r} ] + ( 1 / 4 ) ABC cos [ ( \vec{{G}_{0}} - \vec{{G}_{1}} + \vec{{G}_{2}} ) \cdot \vec{r} ] + ( 1 / 4 ) ABC cos [ ( \vec{{G}_{0}} - \vec{{G}_{1}} - \vec{{G}_{2}} ) \cdot \vec{r} ] \qquad ( 6 )$$

The color moire of a tertiary color corresponds to one having the lowest spatial frequency of four terms in Formula (6). The other terms can be ignored as they have high frequencies.

Similar to Formulas (3) and (4), a third color, which has a periodic structure of a main vector e₀ and a sub vector e₁, is expanded as follows:

$$Periodic Function 3 h ( \vec{r} ) = {V}_{00} + {\sum }_{p = l}^{∞} {V}_{0 p} cos [ \vec{{{pf}_{1}}^{}} \cdot \vec{r} ] \\ \begin{matrix}\vec{{f}_{0}} = 2 π ( \vec{{e}_{1}} \times \vec{{e}_{z}} ) / ( {\vec{{e}_{0}} \cdot ( \vec{{e}_{1}} \times \vec{{e}_{z}} ) )}^{} \\ \vec{{f}_{1}} = 2 π ( \vec{{e}_{z}} \times \vec{{e}_{0}} ) / ( {\vec{{e}_{0}} \cdot ( \vec{{e}_{1}} \times \vec{{e}_{z}} ) )}^{} \\ \end{matrix} \\ ( \vec{{e}_{z}} is a vector orthogonal to \vec{{e}_{0}} and \vec{{e}_{1}} , having a magnitude of 1 ) \qquad ( 7 )$$

As for multiplication of Formulas (3), (4), and (7), there are 27 (=3×3×3) combinations of cosine waves (if Fourier series expansions up to third order are performed). The beat amplitude and the beat spatial frequency vector of each of the 27 combinations are calculated. Accordingly, the beat amplitude of the tertiary color is (¼)·T₀₁·U₀ₙ·V₀ₚ, and the spatial frequency vector of the beat is a vector that minimizes the magnitude of a combination of three vectors of lb₁, nd₁, and pf₁. The suffix “j” used in the embodiments identifies these 27 combinations.

In the tertiary color as described above, some of these 27 combinations might have the same beat spatial frequency. Therefore, for later processes, combinations having exactly the same beat spatial frequency are merged into one (i.e., individual beat amplitudes of the combinations having the same beat spatial frequency are added to one of them).

In the secondary colors having a linear periodic structure, the above operation is unnecessary because there are no combinations that have exactly the same beat spatial frequency.

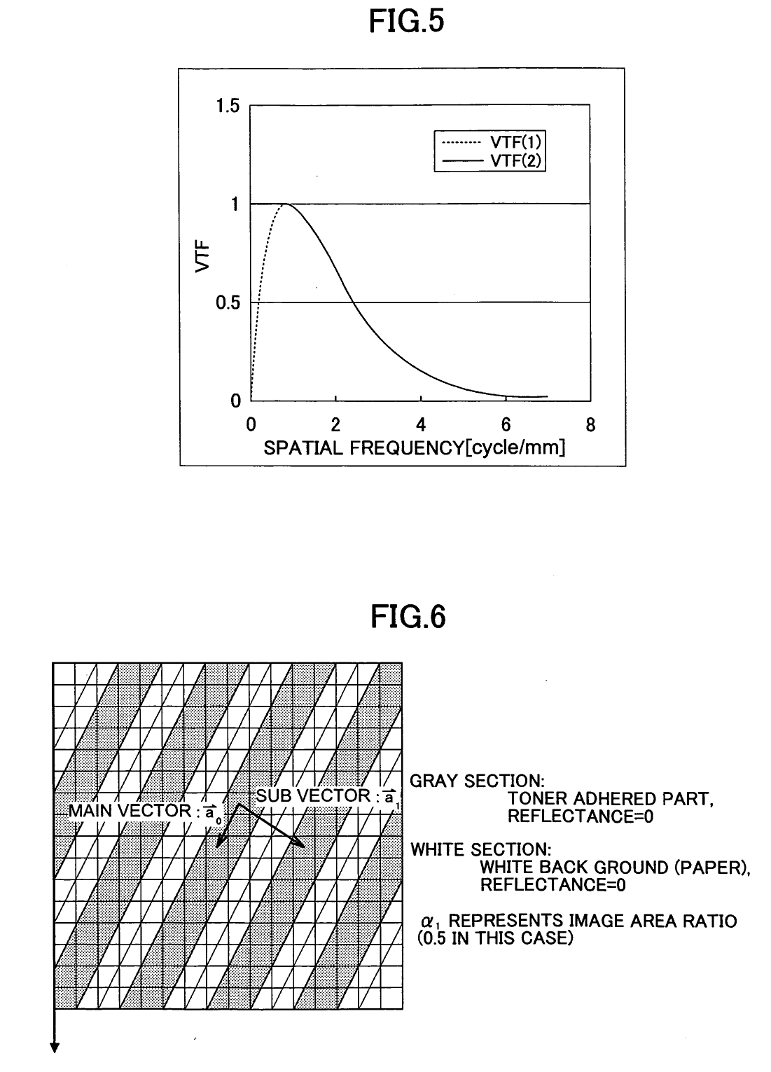

The following describes a process to extract a visually large beat component in the secondary colors. More specifically, a combination having a high beat amplitude and a low spatial frequency is selected from the above combinations (9 combinations of the secondary colors, and 27 combinations of the tertiary colors). Human visual characteristics are often represented by a VTF (Visual transfer function). The VTF is described in, for example, “Fine Imaging and Hard Copy” from Corona Publishing Co., Ltd. The following function is a VTF of an observation distance of 350 mm that is actually used (FIG. 5).

$$\begin{matrix} VTF ( f ) = 5.05 \times exp ( - 0.843 f ) \times ( 1 - exp ( - 0.611 f ) ) ( 0.79 ≦ f ) \\ = 1.0 ( 0 < f < 0.79 ) \\ = 0.2 ( f = 0 ) \\ f : [ cycle / mm ]\end{matrix} \qquad ( 8 )$$

There are two types of VTF that are often used: one does not lose weight in a low-frequency band as in the above (0.79c/mm-201 lpi or lower) (solid line in FIG. 5), and the other loses weight in the low-frequency band (broken line in FIG. 5). In this invention, the first type of VTF that does not lose weight in the low-frequency band is used. The reason is as follows. When color moire in a low-frequency band is reproduced on an actual output image, low-frequency moire is recognizable, resulting in lowering of the image quality. Therefore, allocating a bad score to the color moire in the low-frequency band using the first type of the VTF may facilitate detection of a better dither set. The VTF at a spatial frequency of 0 is set as follows. A color moire having a spatial frequency of 0 has the same periodic structure as a line screen. In this case, a periodic change as a moire does not occur. However, there is a problem that hue variation due to displacement is recognized. In view of that, the VTF at the spatial frequency of 0 is set to 0.2 in the present invention. As can be appreciated from the form of the function, human eyes have a characteristic that intensity variation in a range of a spatial frequency of 0.79 c/mm or less is the most perceivable. As the spatial frequency increases, the intensity variation becomes less perceivable.

In the present invention, as for the secondary colors, the value of the beat amplitude multiplied by a VTF value calculated based on the magnitude of the spatial frequency vector is considered as the magnitude of a visible beat. Therefore, a combination that makes the value of the beat amplitude multiplied by a VTF value high (this value increases when the beat amplitude is high and the beat spatial frequency is low) is a beat that has a large visual influence. This value is considered as a color moire that occurs due to superposition of two colors, i.e., a color moire score in the secondary colors. In the above example, multiplication of the beat amplitude (referred to as P2i) and the VTF value (referred to as V(f2i)) calculated based on the magnitude of the spatial frequency vector of the beat is performed for each of the 9 combinations. The color moire score is derived by selecting the highest one of the values of the 9 combinations. The above-described beat spatial frequency fi [cycle/mm] is calculated based on the spatial frequency vector (lb₁−nd₁) of the beat by the following Formula (9). The number of lines of the beat (the number of color moire lines) is the same as the beat spatial frequency except for the difference of units.
fᵢ=(Resolution)×|l\overline{b}₁−(n\overline{d}₁)|/(2π×25.4)
fᵢ: [cycle/mm] (9)

In other words, as the highest one of the values of the combinations (9 combinations in the above example) is considered as the color moire score, beats due to superposition of other frequency components have smaller values. Accordingly, having the color moire score satisfying the above-described conditional expression is equivalent to having all the beats due to superposition of all the frequency components satisfying the above-described conditional expression.

Six secondary colors are formed by superposing toner images of four colors of CMYK. The color moire score of each of the six secondary colors is calculated in the same way as described above.

Color moire scores of beat components of the tertiary colors are also calculated in the same manner. More specifically, multiplication of the beat amplitude (P3j) and the VTF value (f3i) calculated based on the magnitude of the spatial frequency vector of the beat is performed for each of the 27 combinations. Then, the color moire score of the tertiary color is derived by selecting the highest one of the values of the 27 combinations. In the case the tertiary colors, as is the case of the secondary colors, as the highest one of the values of the 27 combinations is considered as the color moire score of this tertiary color, other beat spatial frequency components have smaller values. Accordingly, having the color moire score satisfying the above-described conditional expression (the second conditional expression) is equivalent to having all the beats of all the frequency components satisfying the above-described conditional expression.

Four tertiary colors are formed by superposing toner images of four colors of CMYK. The color moire score of each of the four tertiary colors is calculated in the same way as described above.

The color moire score of each of the secondary colors (six colors) and the tertiary colors (four colors) is calculated as described above. Then, when all the color moire score of the secondary and tertiary colors satisfy the above-described conditions, a dither set that reduces color moire can be selected.

As is clear from Formulas (1), (3), and (4), the amplitude of the color moire depends on the expansion coefficient (Tₒₗ, Uₒₙ) of Fourier series expansion. In the present invention, the calculation is performed on the basis that “a toner image has a linear periodic structure represented by a function in which reflectance distribution formed by color material adhesion is normalized at 1.0, . . . ”. Specifically, the calculation is performed on the basis that the reflectance of paper is 1.0 and the reflectance of the toner adhered area is R (=0.0). More specifically, the calculation is performed by replacing the reflection intensity distribution of the toner image by a model shown in FIG. 6. When this model is used, the frequency component can be analytically calculated. In the calculation in this example, α₁ representing the area ratio of the toner adhered area is set to 0.3 (the image area ratio is set to 30%). This is because setting the area ratio of the toner adhered area to 30% makes it possible to consider an influence on high-frequency color moire (components of 1 equal to 2 or greater). This is also because the image intensity of the secondary and tertiary colors is set to a state corresponding to images with medium intensity that makes the color moire more apparent in actual images.
T₀₀=α₁·R+(1−α₁)=0.7
T₀₁=2(R−1)sin(πlα₁)/πl=2(−1)sin(π1×0.3)/πl
Tₖ₀=0
Tₖ₁=0 (10)

This expansion coefficient does not depend on the periodic structure, and U₀ₙ, V₀ₚ, etc., have the same value as the above-described T₀₁.

A method for calculating frequency components is not limited to the above-described method, and may include a method for calculating dots of a dither matrix that have shapes representing actual shapes more accurately. Although a method for calculating dots of a dither matrix that have shapes representing actual shapes more accurately does not cause a big problem, this method complicate the calculation, includes numerical calculations, and therefore requires a longer calculation time than the method of the present invention. The difference between these two methods is only found as a difference in higher-order frequency components in Fourier series expansions, and little difference exists in lower-order frequency components that contribute to color moire. As mentioned above, the order of the frequency component that contributes color moire is about up to the third order, and higher-order frequency components hardly contribute to color moire. Therefore, color moire scores calculated by these two methods are almost the same. By applying Tₒ₁ as the expansion coefficient of the above-described Fourier series expansion and U₀ₙ having the same value to Formulas (3) and (4), the value of (½)·Tₒₗ·U₀ₙ as the amplitude of the beat can be calculated.

Color moire scores of the dither matrices of the four colors of CMYK shown in Table 21 of Embodiment 1 calculated by the above-described method are shown in Table 22. The ten values in the rightmost column represent color moire scores of the secondary colors (six colors) and the tertiary colors (four colors). The highest (worst) one of these ten values is the color moire score of this dither matrix set (0.0082 in this example).

TABLE 22

| | | | | | |
|---|---|---|---|---|---|
| | Moire | | | Color | |
| | line | Moire angle | | moire | Color moire |
| Combination | [lpi] | [deg.] | VTF | amplitude | score |

Secondary color

| | | | | | |
|---|---|---|---|---|---|
| 0-1 | 212.1 | 45.0 | 0.0040 | 0.126 | 0.0006 |
| 0-2 | 150.0 | 0.0 | 0.0340 | 0.126 | 0.0045 |
| 0-3 | 150.0 | 0.0 | 0.0340 | 0.126 | 0.0045 |
| 1-2 | 150.0 | 90.0 | 0.0340 | 0.126 | 0.0045 |
| 1-3 | 150.0 | 90.0 | 0.0340 | 0.126 | 0.0045 |
| 2-3 | 300.0 | 0.0 | 0.0000 | 0.126 | 0.0000 |

Tertiary color

| | | | | | |
|---|---|---|---|---|---|
| 0-1-2 | 0.0 | 0.0 | 0.2000 | 0.038 | 0.0081 |
| 0-1-3 | 0.0 | 0.0 | 0.2000 | 0.038 | 0.0081 |
| 0-2-3 | 0.0 | 0.0 | 0.2000 | 0.019 | 0.0039 |
| 1-2-3 | 0.0 | 0.0 | 0.2000 | 0.019 | 0.0039 |

According to Embodiment 1, Table 22 indicates that among the six secondary colors and four tertiary colors, a tertiary color of a dither matrix combination of 0-1-2 and a tertiary color of a dither matrix combination of 0-1-3 have the highest (worst) color moire scores. Namely, the color moire score of the dither matrix set of Embodiment 1 is 0.0082.

In Embodiment 1, the above-described CMYK dither matrix combination is employed to prevent occurrence of visible color moire not only in the secondary colors but also in the tertiary colors. As the color moire score value of the dither set of Embodiment 1 is 0.0082, which is considered as very preferable (low), color moire is hardly perceived on an output image.

The calculation procedure of the color moire score of a dither set is explained below by giving a specific example.

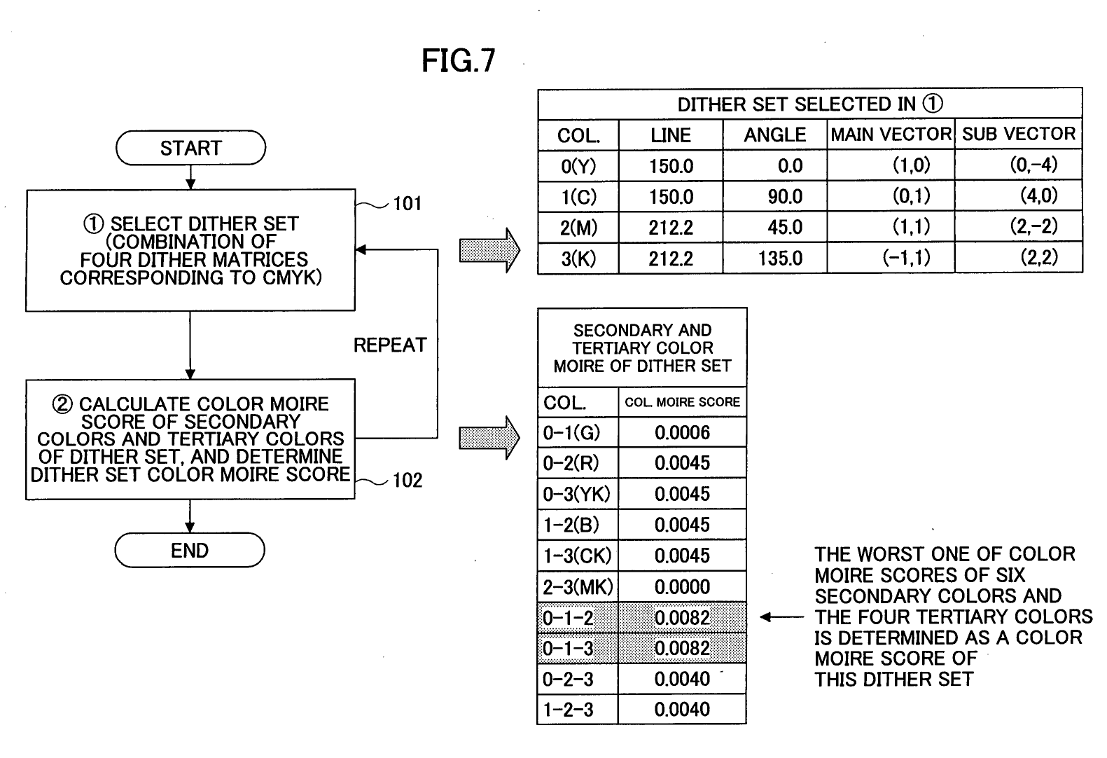

FIG. 7 illustrates a procedure used by the color moire score calculator 1 to calculate a color moire score of a dither. In Step 101, a dither set (a combination of four dither matrices) is selected from the dither matrix storage 2. In this example, the dither set of Embodiment 1 (a combination shown at the upper right side of FIG. 7) is selected.

Then, in Step 102, the color moire score of each of the secondary colors (six colors) and the tertiary colors (four colors) of the dither set selected in Step 101 is calculated (the calculation method is described below in detail). The color moire score values of the six secondary colors and the four tertiary colors of this example are shown in the table shown at the lower right side of FIG. 7.

Then, the worst one (the one having the highest value) of the ten color moires is extracted, and determined as the color moire score of this dither set. In this example, as the value 0.0082 is the highest, the color moire score of the dither set is determined as 0.0082.

By taking the above-described procedure, the color moire score of the selected dither set is calculated. In actual calculations, a calculation loop (program) sequentially calculates color moire scores of many dither sets. With this method, dither sets having preferable color moire scores are detected, which are disclosed as embodiments of the present invention.

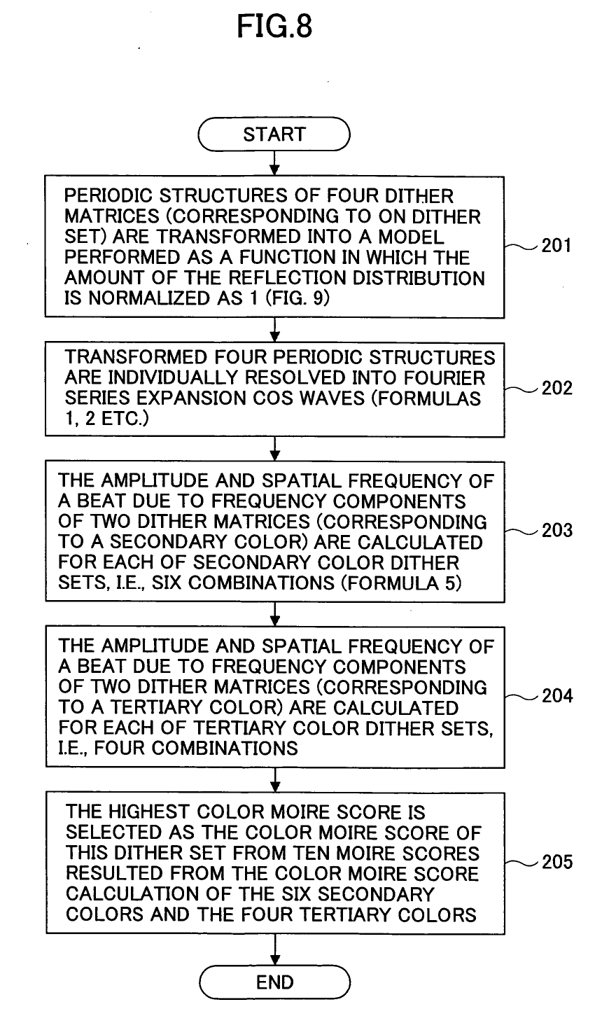

The following describes Step 102 (calculation of color moire scores of secondary and tertiary colors) of FIG. 7 in greater detail. FIG. 8 illustrates a procedure for calculating a color moire score of a dither set.

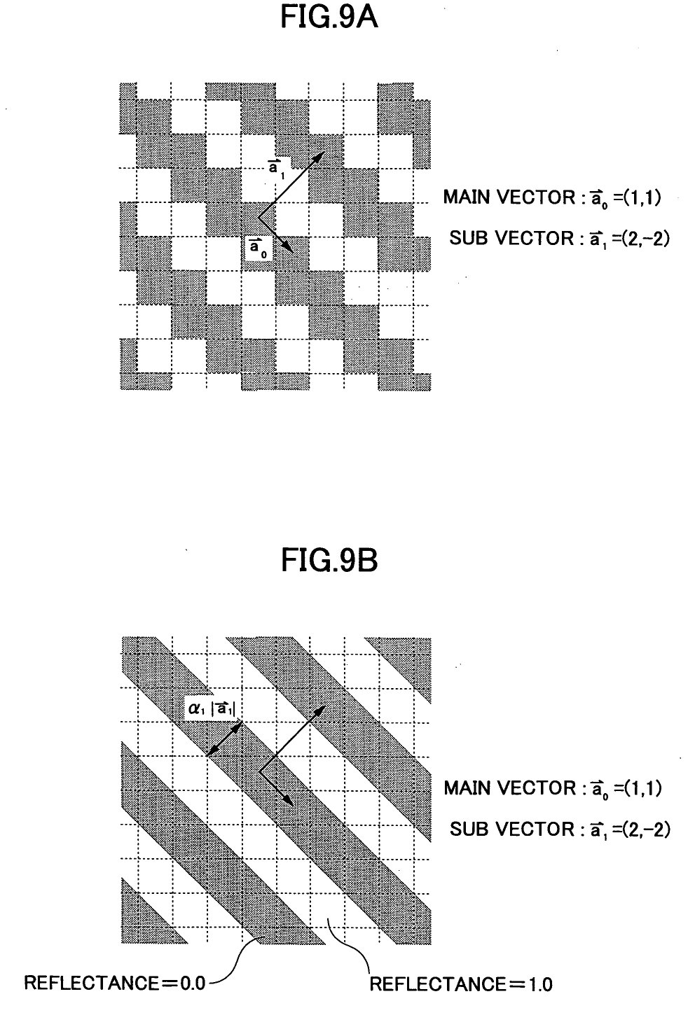

In step 201, each of the periodic structures of two dither matrices is modeled as a function in which reflectance distribution is normalized at 1. FIGS. 9A and 9B show the example of modeling. The expression “modeled as a function in which reflectance distribution is normalized to 1” means “modeled on the basis that the reflectance of a toner adhered area is 0.0 and the reflectance of the toner non-adhered area is 1.0” In step 201 of FIG. 8, toner adhered areas of a dithered image having a shape as shown in FIG. 9A are modeled by transforming the areas to lines parallel to the main vector. The line width in a direction of a sub vector is equal to α₁ times of the length of the sub vector (the line width is determined depending on the value of α₁ which ranges 0 through 1). This modeling is performed to simplify calculation of Fourier series expansion. Although Fourier series expansion can be performed without modifying the shapes shown in FIG. 9A, the calculation without modeling is more complicated (takes a longer time). Moreover, the modeling makes little difference in results of color moire score calculation in a subsequent step. For these reasons, the modeling to the shapes as shown in FIG. 9B is performed.

In step 202, Fourier series expansion of the periodic structure modeled in Step 201 is performed. As the periodic structures are modeled as shown in FIG. 9B, the expansion coefficient of Fourier series expansion (Tₖ₁ of Formula (1)) is calculated as in Formula (10).

When the suffixes k and l Formula (1) of Fourier series expansion take the values 0 through 3, a constant term (T₀₀) and three terms of cosine waves result from the conversion (this is because when the suffix k is not equal to 0, the suffix coefficient Tₖ₁ becomes 0). Expansion coefficient Tₖ₁ and spatial frequency vector kb₀+lb₁ of the resulting cosine waves are shown in Table 23. Table 23 shows calculation results of the dither set of Embodiment 1 as an example.

In this calculation, the value of α₁ representing the line width is set to 0.3 (this means that the area ratio of the toner adhered area is 30%). This is because setting the area ratio of the toner adhered area to 30% makes it possible to consider the influence on high-frequency color moire (components of l≦2). This is also so that the image intensity of the secondary and tertiary colors is set corresponding to images with medium intensity, which makes the color moire more apparent in actual images, and taken into consideration.

TABLE 23

| | | | Spatial frequency vector | | Expansion |
|---|---|---|---|---|---|
| No. | k | l | x component | y component | coefficient Tkl |

0th color
Fourier series expansion
Periodic vector: \vec{a}₀ = (1, 0), \vec{a}₁ = (0, −4)

| | | | | | |
|---|---|---|---|---|---|
| 0 | 0 | 1 | 0.00 | −1.57 | 0.5150 |
| 1 | 0 | 2 | 0.00 | −3.14 | 0.3027 |
| 2 | 0 | 3 | 0.00 | −4.71 | 0.0656 |

1st color
Fourier series expansion
Periodic vector: \vec{a}₀ = (0, 1), \vec{a}₁ = (4, 0)

| | | | | | |
|---|---|---|---|---|---|
| 0 | 0 | 1 | 1.57 | 0.00 | 0.5150 |
| 1 | 0 | 2 | 3.14 | 0.00 | 0.3027 |
| 2 | 0 | 3 | 4.71 | 0.00 | 0.0656 |

2nd color
Fourier series expansion
Periodic vector: \vec{a}₀ = (1, 1), \vec{a}₁ = (2, −2)

| | | | | | |
|---|---|---|---|---|---|
| 0 | 0 | 1 | 1.57 | −1.57 | 0.5150 |
| 1 | 0 | 2 | 3.14 | −3.14 | 0.3027 |
| 2 | 0 | 3 | 4.71 | −4.71 | 0.0656 |

3rd color
Fourier series expansion
Periodic vector: \vec{a}₀ = (−1, 1), \vec{a}₁ = (2, 2)

| | | | | | |
|---|---|---|---|---|---|
| 0 | 0 | 1 | 1.57 | 1.57 | 0.5150 |
| 1 | 0 | 2 | 3.14 | 3.14 | 0.3027 |
| 2 | 0 | 3 | 4.71 | 4.71 | 0.0656 |

Then, in step 203, the amplitude (P2i) and the spatial frequency (f2i) of a beat that occurs due to respective components of two periodic structures are calculated (corresponding to color moire of secondary colors). In the following example, the two periodic structures correspond to the 0th and 2nd colors of Table 23 (the 0th and 2nd colors of the dither set of Embodiment 1).

As each of the 0th and 2nd colors of Table 23 is converted into three terms of cosine waves, there are 9 (=3×3) combinations of cosine wave multiplication. Table 24 shows the calculation results.

TABLE 24
Beat amplitude (P2i) and beat spatial frequency (f2i) in
secondary color are calculated for each cos wave combination

| No. | | Beat spatial frequency | | | VTF | Beat | P2i * VTF |
|---|---|---|---|---|---|---|---|
| Suffix i | Combination | x component | y component | f2i [c/mm] | (f2i) | amplitude P2i | (f2i) |
| 0 | 0-0 | −1.57 | 3.14 | 13.21 | 0.000 | 0.1326 | 0.0000 |
| 1 | 0-0 | 1.57 | 0.00 | 5.91 | 0.034 | 0.1326 | 0.0045 |
| 2 | 0-1 | −3.14 | 4.71 | 21.29 | 0.000 | 0.0780 | 0.0000 |
| 3 | 0-1 | −3.14 | 1.57 | 13.21 | 0.000 | 0.0780 | 0.0000 |
| 4 | 0-2 | −4.71 | 6.28 | 29.53 | 0.000 | 0.0169 | 0.0000 |
| 5 | 0-2 | −4.71 | 3.14 | 21.29 | 0.000 | 0.0169 | 0.0000 |
| 6 | 1-0 | −1.57 | 4.71 | 18.67 | 0.000 | 0.0780 | 0.0000 |
| 7 | 1-0 | 1.57 | 1.57 | 8.35 | 0.004 | 0.0780 | 0.0003 |
| 8 | 1-1 | −3.14 | 6.28 | 26.41 | 0.000 | 0.0458 | 0.0000 |
| 9 | 1-1 | 3.14 | 0.00 | 11.81 | 0.000 | 0.0458 | 0.0000 |
| 10 | 1-2 | −4.71 | 7.85 | 34.43 | 0.000 | 0.0099 | 0.0000 |
| 11 | 1-2 | −4.71 | 1.57 | 18.67 | 0.000 | 0.0099 | 0.0000 |
| 12 | 2-0 | −1.57 | 6.28 | 24.35 | 0.000 | 0.0169 | 0.0000 |
| 13 | 2-0 | 1.57 | 3.14 | 13.21 | 0.000 | 0.0169 | 0.0000 |
| 14 | 2-1 | −3.14 | 7.85 | 31.80 | 0.000 | 0.0099 | 0.0000 |
| 15 | 2-1 | 3.14 | 1.57 | 13.21 | 0.000 | 0.0099 | 0.0000 |
| 16 | 2-2 | −4.71 | 9.42 | 39.62 | 0.000 | 0.0022 | 0.0000 |
| 17 | 2-2 | 4.71 | 0.00 | 17.72 | 0.000 | 0.0022 | 0.0000 |

In Table 24, the same combination appears two times. This is because, as is clear from Formula (5), multiplication of two cosine waves is represented by superposition (addition) of two cosine waves. In Table 24, the upper one of the same combinations corresponds to the second term of Formula (5), and the lower one corresponds to the first term of Formula (5).

The beat amplitude (P2i) and the beat spatial frequency (f2i) are calculated as follows. For example, in the case of the combination in the first row (suffix i=1) of Table 24, the beat spatial frequency (P2i) corresponds to multiplication of cosine waves having spatial frequency vectors of No. 0 of the 0th color of Table 23 and No. 0 of the second color of Table 23. The beat spatial frequency vector of the first row of Table 24 is equal to the difference between these two spatial frequency vectors (the sum of these two spatial frequency vectors corresponds to the beat spatial frequency vector of the 0th row (suffix=0) of Table 24). The beat spatial frequency vector is multiplied by −1 in some cases so as to be oriented within 0 through 180 degrees (because the waveform of a cosine frequency vector is not changed by multiplication by −1). This beat spatial frequency vector is applied to Formula (9) so as to calculate the beat spatial frequency (f2i) (the beat spatial frequency is calculated by multiplying the magnitude of the beat spatial frequency vector by the resolution, and then dividing by (2π×25.4)

The beat amplitude (P2i) can be calculated by, in the case of the combination in the first row in Table 24, multiplying Tₖ₁ of No. 0 of the 0th color by Tₖ₁ of No. 0 of the 2nd color shown in Table 23, and then by multiplying the resulting product by ½.

VTF (f2i) of Table 24 is calculated by applying the beat spatial frequency (f2i) to Formula (8). P2i*VTF(f2i) is calculated by multiplying the beat amplitude (P2i) by VTF(f2i).

The visually highest beat is extracted from Table 24, and the value of the extracted beat is defined as the color moire score of the secondary color (the secondary color formed by the 0th color and the 2nd color). Specifically, in Table 24, the combination having the highest value of P2i*VTF(f2i) is extracted as it corresponds to the visually highest beat. For example, the color moire score can be calculated by sorting Table 24 in the order of the value of P2i*VTF(f2i). Table 25 shows Table 24 sorted in the order of P2i*VTF(f2i).

TABLE 25
Extract the visually highest beat
The highest value of P2i * VTF(f2i) is defined as the color moire score

| No. | | Beat spatial frequency | | | VTF | Beat | P2i * VTF |
|---|---|---|---|---|---|---|---|
| Suffix i | Combination | x component | y component | f2i [c/mm] | (f2i) | amplitude P2i | (f2i) |
| 1 | 0-0 | 1.57 | 0.00 | 5.91 | 0.034 | 0.1326 | 0.0045 |
| 7 | 1-0 | 1.57 | 1.57 | 8.35 | 0.004 | 0.0780 | 0.0003 |
| 0 | 0-0 | −1.57 | 3.14 | 13.21 | 0.000 | 0.1326 | 0.0000 |
| 3 | 0-1 | −3.14 | 1.57 | 13.21 | 0.000 | 0.0780 | 0.0000 |
| 9 | 1-1 | 3.14 | 0.00 | 11.81 | 0.000 | 0.0458 | 0.0000 |
| 2 | 0-1 | −3.14 | 4.71 | 21.29 | 0.000 | 0.0780 | 0.0000 |
| 4 | 0-2 | −4.71 | 6.28 | 29.53 | 0.000 | 0.0169 | 0.0000 |
| 5 | 0-2 | −4.71 | 3.14 | 21.29 | 0.000 | 0.0169 | 0.0000 |
| 6 | 1-0 | −1.57 | 4.71 | 18.67 | 0.000 | 0.0780 | 0.0000 |
| 8 | 1-1 | −3.14 | 6.28 | 26.41 | 0.000 | 0.0458 | 0.0000 |
| 10 | 1-2 | −4.71 | 7.85 | 34.43 | 0.000 | 0.0099 | 0.0000 |
| 11 | 1-2 | −4.71 | 1.57 | 18.67 | 0.000 | 0.0099 | 0.0000 |
| 12 | 2-0 | −1.57 | 6.28 | 24.35 | 0.000 | 0.0169 | 0.0000 |
| 13 | 2-0 | 1.57 | 3.14 | 13.21 | 0.000 | 0.0169 | 0.0000 |
| 14 | 2-1 | −3.14 | 7.85 | 31.80 | 0.000 | 0.0099 | 0.0000 |
| 15 | 2-1 | 3.14 | 1.57 | 13.21 | 0.000 | 0.0099 | 0.0000 |
| 16 | 2-2 | −4.71 | 9.42 | 39.62 | 0.000 | 0.0022 | 0.0000 |
| 17 | 2-2 | 4.71 | 0.00 | 17.72 | 0.000 | 0.0022 | 0.0000 |

It is found from Table 25 that the color moire score of the color moire that occurs between these two dither matrices (the 0th color and the second color) is 0.0045. In the same manner, calculation of a color moire score of color moire that occurs between two dither matrices (secondary color) is performed for each of secondary color dither sets, i.e., six combinations. The calculation results are shown in the table at the lower right table of FIG. 7 and in Table 22.

Then, in Step 204, the amplitude (P3i) and the spatial frequency (f3i) of a beat that occurs due to respective components of three periodic structures are calculated (corresponding to color moire of tertiary colors). The three periodic structures, for example, correspond to the 0th, 1st, and 2nd colors in Table 23. As the 0th, 1st, and 2nd colors are converted into three cosine waves each having three terms as shown in Table 23, there are 27 (=3×3×3) combinations of beats. Table 26 shows the calculation results.

TABLE 26
Beat amplitude (P3i) and beat spatial frequency (f3i) in
tertiary color are calculated for each cos wave combination

| No. | | Beat spatial frequency | | | VTF | Beat | P3i * VTF |
|---|---|---|---|---|---|---|---|
| Suffix i | Combination | x component | y component | f3i [c/mm] | (f3i) | amplitude P3i | (f3i) |
| 0 | 0-0-0 | −3.14 | 3.14 | 16.70 | 0.000 | 0.0342 | 0.0000 |
| 1 | 0-0-0 | 0.00 | 0.00 | 0.00 | 0.200 | 0.0342 | 0.0068 |
| 2 | 0-0-0 | 0.00 | 3.14 | 11.81 | 0.000 | 0.0342 | 0.0000 |
| 3 | 0-0-0 | 3.14 | 0.00 | 11.81 | 0.000 | 0.0342 | 0.0000 |
| 4 | 0-0-1 | −4.71 | 4.71 | 25.05 | 0.000 | 0.0201 | 0.0000 |
| 5 | 0-0-1 | −1.57 | 1.57 | 8.35 | 0.004 | 0.0201 | 0.0001 |
| 6 | 0-0-1 | −1.57 | 4.71 | 18.67 | 0.000 | 0.0201 | 0.0000 |
| 7 | 0-0-1 | −4.71 | 1.57 | 18.67 | 0.000 | 0.0201 | 0.0000 |
| 8 | 0-0-2 | −6.28 | 6.28 | 33.41 | 0.000 | 0.0044 | 0.0000 |
| 9 | 0-0-2 | −3.14 | 3.14 | 16.70 | 0.000 | 0.0044 | 0.0000 |
| 10 | 0-0-2 | −3.14 | 6.28 | 26.41 | 0.000 | 0.0044 | 0.0000 |
| 98 | 2-2-0 | 3.14 | 6.28 | 26.41 | 0.000 | 0.0006 | 0.0000 |
| 99 | 2-2-0 | 6.28 | 3.14 | 26.41 | 0.000 | 0.0006 | 0.0000 |
| 100 | 2-2-1 | −7.85 | 7.85 | 41.76 | 0.000 | 0.0003 | 0.0000 |
| 101 | 2-2-1 | −1.57 | 1.57 | 8.35 | 0.000 | 0.0003 | 0.0000 |
| 102 | 2-2-1 | 1.57 | 7.85 | 30.11 | 0.000 | 0.0003 | 0.0000 |
| 103 | 2-2-1 | 7.85 | 1.57 | 30.11 | 0.000 | 0.0003 | 0.0000 |
| 104 | 2-2-2 | −9.42 | 9.42 | 50.11 | 0.000 | 0.0001 | 0.0000 |
| 105 | 2-2-2 | 0.00 | 0.00 | 0.00 | 0.143 | 0.0001 | 0.0000 |
| 106 | 2-2-2 | 0.00 | 9.42 | 35.43 | 0.000 | 0.0001 | 0.0000 |
| 107 | 2-2-2 | 9.42 | 0.00 | 35.43 | 0.000 | 0.0001 | 0.0000 |

In Table 26, the same combination appears four times. This is because, as is clear from Formula (6), multiplication of three cosine waves is represented by superposition (addition) of four cosine waves. In Table 26, the uppermost one of the same combinations corresponds to the first term of Formula (6); the second uppermost one corresponds to the second term of Formula (6); the third uppermost one corresponds to the third term of Formula (6); the second uppermost one corresponds to the second term of Formula (6); and the lowest one corresponds to the fourth term of Formula (6).

The beat amplitude (P3i) and the beat spatial frequency (f3i) are calculated as follows. For example, in the case of the combination in the 0th row (suffix i=0) of Table 26, the beat spatial frequency (P3i) corresponds to multiplication of cosine waves having spatial frequency vectors of No. 0 of the 0th color of Table 23, No. 0 of the 1st color of Table 23, and No. 0 of the second color of Table 23. The beat spatial frequency vector of the 0th row of Table 26 is equal to the sum of these three spatial frequency vectors (the beat spatial frequency vector is multiplied by −1 in some cases so as to be oriented within 0 through 180 degrees). This beat spatial frequency vector is applied to Formula (9) so as to calculate the beat spatial frequency (f3i) (the beat spatial frequency is calculated by multiplying the magnitude of the beat spatial frequency vector by the resolution, and then dividing by (2π×25.4) The beat amplitude (P3i) can be calculated by, in the case of the combination in the 0th row in Table 26, doing multiplication of Tₖ₁ of the 0th color, Tₖ₁ of the 1st color, and Tₖ₁ of the 2nd color shown in Table 23, and then by multiplying the resulting product by ¼.

VTF (f3i) of Table 26 is calculated by applying the beat spatial frequency (f3i) to Formula (8). P3i*VTF(f3i) is calculated by multiplying the beat amplitude (P3i) by VTF(f3i).

Then, the visually highest beat is extracted from Table 26, and the value of the extracted beat is defined as the color moire score of the tertiary color (the tertiary color formed by the 0th color, the 1st color, and the 2nd color of Table 23). Specifically, in Table 26, the combination having the highest value of p3i*VTF(f3i) is extracted as it corresponds to the visually highest beat. For example, the color moire score can be calculated by sorting Table 26 in the order of the value of P3i*VTF(f3i). Table 27 shows Table 26 sorted in the order of P3i*VTF(f3i).

TABLE 27
Extract the visually highest beat
Sorted in the descending order of P3i * VTF(f3i)

| No. | | Beat spatial frequency | | | VTF | Beat | P3i * VTF |
|---|---|---|---|---|---|---|---|
| Suffix i | Combination | x component | y component | f3i [c/mm] | (f3i) | amplitude P3i | (f3i) |
| 1 | 0-0-0 | 0.00 | 0.00 | 0.00 | 0.200 | 0.0342 | 0.0068 |
| 53 | 1-1-1 | 0.00 | 0.00 | 0.00 | 0.200 | 0.0069 | 0.0014 |
| 13 | 0-1-0 | 1.57 | 0.00 | 5.91 | 0.034 | 0.0201 | 0.0007 |
| 37 | 1-0-0 | 0.00 | 1.57 | 5.91 | 0.034 | 0.0201 | 0.0007 |
| 17 | 0-1-1 | 0.00 | 1.57 | 5.91 | 0.034 | 0.0118 | 0.0004 |
| 41 | 1-0-1 | 1.57 | 0.00 | 5.91 | 0.034 | 0.0118 | 0.0004 |
| 5 | 0-0-1 | −1.57 | 1.57 | 8.35 | 0.004 | 0.0201 | 0.0001 |
| 49 | 1-1-0 | −1.57 | 1.57 | 8.35 | 0.004 | 0.0118 | 0.0001 |
| 65 | 1-2-1 | 1.57 | 0.00 | 5.91 | 0.033 | 0.0015 | 0.0001 |
| 89 | 2-1-1 | 0.00 | 1.57 | 5.91 | 0.033 | 0.0015 | 0.0001 |
| 2 | 0-0-0 | 0.00 | 3.14 | 11.81 | 0.000 | 0.0342 | 0.0000 |
| 97 | 2-2-0 | −3.14 | 3.14 | 16.70 | 0.000 | 0.0006 | 0.0000 |
| 98 | 2-2-0 | 3.14 | 6.28 | 26.41 | 0.000 | 0.0006 | 0.0000 |
| 99 | 2-2-0 | 6.28 | 3.14 | 26.41 | 0.000 | 0.0006 | 0.0000 |
| 100 | 2-2-1 | −7.85 | 7.85 | 41.76 | 0.000 | 0.0003 | 0.0000 |
| 101 | 2-2-1 | −1.57 | 1.57 | 8.35 | 0.000 | 0.0003 | 0.0000 |
| 102 | 2-2-1 | 1.57 | 7.85 | 30.11 | 0.000 | 0.0003 | 0.0000 |
| 103 | 2-2-1 | 7.85 | 1.57 | 30.11 | 0.000 | 0.0003 | 0.0000 |
| 104 | 2-2-2 | −9.42 | 9.42 | 50.11 | 0.000 | 0.0001 | 0.0000 |
| 106 | 2-2-2 | 0.00 | 9.42 | 35.43 | 0.000 | 0.0001 | 0.0000 |
| 107 | 2-2-2 | 9.42 | 0.00 | 35.43 | 0.000 | 0.0001 | 0.0000 |

In the case of tertiary colors, there might be combinations that have the same beat spatial frequency vector. For example, in Table 27, combinations with suffix i=1, i=53, and i=105 have the same beat spatial frequency vector. In such a case, one of the combinations is selected to represent the other combinations, and the beat amplitude of the combinations not selected are added to the beat amplitude of the selected combination (then, the beat amplitude of the combinations not selected is set to 0). In this example, the combination i=1 is selected to represent the combinations i=1 and 105 of which beat amplitude (P3i) are 0.0069 and 0.0001, respectively. Therefore, the beat amplitude of the combination i=0 becomes 0.0412 by addition of the beat amplitude of these three combinations. In Table 28, combinations having the same spatial frequency vector shown in Table 27 are represented by one of them through addition of the beat amplitude.

TABLE 28
The highest value of P3i * VTF(f3i) is defined as the color moire score
after combinations having the same beat spatial frequency are
represented by one of them

| No. | | Beat spatial frequency | | | VTF | Beat | P3i * VTF |
|---|---|---|---|---|---|---|---|
| Suffix i | Combination | x component | y component | f3i [c/mm] | (f3i) | amplitude P3i | (f3i) |
| 1 | 0-0-0 | 0.00 | 0.00 | 0.00 | 0.200 | 0.0412 | 0.0082 |
| 53 | 1-1-1 | 0.00 | 0.00 | 0.00 | 0.200 | to 1 | — |
| 13 | 0-1-0 | 1.57 | 0.00 | 5.91 | 0.034 | 0.0337 | 0.0011 |
| 37 | 1-0-0 | 0.00 | 1.57 | 5.91 | 0.034 | 0.0337 | 0.0011 |
| 17 | 0-1-1 | 0.00 | 1.57 | 5.91 | 0.034 | to 37 | — |
| 41 | 1-0-1 | 1.57 | 0.00 | 5.91 | 0.034 | to 13 | — |
| 5 | 0-0-1 | −1.57 | 1.57 | 8.35 | 0.004 | 0.0337 | 0.0002 |
| 49 | 1-1-0 | −1.57 | 1.57 | 8.35 | 0.004 | to 5 | — |
| 65 | 1-2-1 | 1.57 | 0.00 | 5.91 | 0.033 | to 13 | — |
| 89 | 2-1-1 | 0.00 | 1.57 | 5.91 | 0.033 | to 37 | — |
| 2 | 0-0-0 | 0.00 | 3.14 | 11.81 | 0.000 | 0.0391 | 0.0000 |

It is found from these calculations that the color moire score of the tertiary color of this combination example is 0.0082. In the same manner, calculation of color moire score of color moire that occurs among three dither matrices (tertiary color) is performed for each of tertiary color dither sets, i.e., four combinations. The calculation results are shown in the table at the lower right table of FIG. 7 and in Table 22.

Thus, the highest (worst) moire color score is selected as the color moire score of this dither set from ten color moire scores resulted from the color moire score calculation of the six secondary colors and the color moire score calculation of the four tertiary colors (Step 205).

### Embodiment 2

Dither matrices of four colors of CMYK of Embodiment 2 are shown in Table 29. As in Embodiment 1, calculation of color moire scores of secondary colors and tertiary colors is performed in Embodiment 2, of which results are shown in Table 30.

TABLE 29

| No. | Line [lpi] | Angle [deg.] | a0x | a0y | a1x | a1y |
|---|---|---|---|---|---|---|
| 0 | 191.7 | 26.6 | 2 | 1 | 1 | −3 |
| 1 | 191.7 | 63.4 | 1 | 2 | 3 | −1 |
| 2 | 191.7 | 116.6 | −1 | 2 | 3 | 1 |
| 3 | 191.7 | 153.4 | −2 | 1 | 1 | 3 |

TABLE 30

| | | | | | |
|---|---|---|---|---|---|
| | Moire | | | Color | |
| | line | Moire angle | | moire | Color moire |
| Combination | [lpi] | [deg.] | VTF | amplitude | score |

Secondary color

| | | | | | |
|---|---|---|---|---|---|
| 0-1 | 121.2 | 45.0 | 0.0850 | 0.126 | 0.0112 |
| 0-2 | 271.1 | 71.6 | 0.0010 | 0.126 | 0.0001 |
| 0-3 | 171.4 | 0.0 | 0.0170 | 0.126 | 0.0022 |
| 1-2 | 171.4 | 90.0 | 0.0170 | 0.126 | 0.0022 |
| 1-3 | 271.1 | 18.4 | 0.0010 | 0.126 | 0.0001 |
| 2-3 | 121.2 | 135.0 | 0.0850 | 0.126 | 0.0112 |

Tertiary color

| | | | | | |
|---|---|---|---|---|---|
| 0-1-2 | 85.7 | 0.0 | 0.2560 | 0.032 | 0.0086 |
| 0-1-3 | 85.7 | 90.0 | 0.2560 | 0.032 | 0.0086 |
| 0-2-3 | 85.7 | 90.0 | 0.2560 | 0.032 | 0.0086 |
| 1-2-3 | 85.7 | 0.0 | 0.2560 | 0.032 | 0.0086 |

According to Embodiment 2, Table 30 indicates that among six secondary colors and four tertiary colors, a tertiary color of the dither matrix combination of 0-1 and a tertiary color of the dither matrix combination of 2-3 have the highest (worst) color moire score. Namely, the color moire score of the dither set of Embodiment 2 is 0.0112.

In Embodiment 2, the above-described CMYK dither matrix combination is employed to prevent occurrence of visible color moire not only in the secondary colors but also in the tertiary colors. As the color moire score value of the dither set of Embodiment 2 is 0.0112, which is considered as very preferable (low), color moire is hardly perceived on an output image.

### Embodiments 3-20

### Embodiment 3

In this embodiment, a combination of dither matrices shown in Table 31 is employed in an image forming apparatus having the same configuration as the image forming apparatus of Embodiment 1.

TABLE 31

| | Line | Angle | | | | |
|---|---|---|---|---|---|---|
| No. | [lpi] | [deg.] | a0x | a0y | a1x | a1y |
| 0 | 189.7 | 18.4 | 3 | 1 | 1 | −3 |
| 1 | 189.7 | 108.4 | −1 | 3 | 3 | 1 |
| 2 | 191.7 | 63.4 | 1 | 2 | 3 | −1 |
| 3 | 191.7 | 153.4 | −2 | 1 | 1 | 3 |

### Embodiment 4

In this embodiment, a combination of dither matrices shown in Table 32 is employed in an image forming apparatus having the same configuration as the image forming apparatus of Embodiment 1.

TABLE 32

| | Line | Angle | | | | |
|---|---|---|---|---|---|---|
| No. | [lpi] | [deg.] | a0x | a0y | a1x | a1y |
| 0 | 189.7 | 18.4 | 3 | 1 | 1 | −3 |
| 1 | 189.7 | 71.6 | 1 | 3 | 3 | −1 |
| 2 | 189.7 | 108.4 | −1 | 3 | 3 | 1 |
| 3 | 189.7 | 161.6 | −3 | 1 | 1 | 3 |

### Embodiment 5

In this embodiment, a combination of dither matrices shown in Table 33 is employed in an image forming apparatus having the same configuration as the image forming apparatus of Embodiment 1.

TABLE 33

| | Line | Angle | | | | |
|---|---|---|---|---|---|---|
| No. | [lpi] | [deg.] | a0x | a0y | a1x | a1y |
| 0 | 158.1 | 18.4 | 3 | 1 | 0 | −4 |
| 1 | 158.1 | 71.6 | 1 | 3 | 4 | 0 |
| 2 | 191.7 | 116.6 | −1 | 2 | 3 | 1 |
| 3 | 191.7 | 153.4 | −2 | 1 | 1 | 3 |

### Embodiment 6

In this embodiment, a combination of dither matrices shown in Table 34 is employed in an image forming apparatus having the same configuration as the image forming apparatus of Embodiment 1.

TABLE 34

| | Line | Angle | | | | |
|---|---|---|---|---|---|---|
| No. | [lpi] | [deg.] | a0x | a0y | a1x | a1y |
| 0 | 167.7 | 26.6 | 2 | 1 | 2 | −3 |
| 1 | 167.7 | 153.4 | −2 | 1 | 2 | 3 |
| 2 | 191.7 | 63.4 | 1 | 2 | 3 | −1 |
| 3 | 191.7 | 116.6 | −1 | 2 | 3 | 1 |

### Embodiment 7

In this embodiment, a combination of dither matrices shown in Table 35 is employed in an image forming apparatus having the same configuration as the image forming apparatus of Embodiment 1.

TABLE 35

| | Line | Angle | | | | |
|---|---|---|---|---|---|---|
| No. | [lpi] | [deg.] | a0x | a0y | a1x | a1y |
| 0 | 166.4 | 33.7 | 3 | 2 | 2 | −3 |
| 1 | 167.7 | 153.4 | −2 | 1 | 2 | 3 |
| 2 | 189.7 | 71.6 | 1 | 3 | 3 | −1 |
| 3 | 191.7 | 116.6 | −1 | 2 | 3 | 1 |

### Embodiment 8

In this embodiment, a combination of dither matrices shown in Table 36 is employed in an image forming apparatus having the same configuration as the image forming apparatus of Embodiment 1.

TABLE 36

| | Line | Angle | | | | |
|---|---|---|---|---|---|---|
| No. | [lpi] | [deg.] | a0x | a0y | a1x | a1y |
| 0 | 172.5 | 18.4 | 3 | 1 | 2 | −3 |
| 1 | 172.5 | 71.6 | 1 | 3 | 3 | −2 |
| 2 | 189.7 | 108.4 | −1 | 3 | 3 | 1 |
| 3 | 189.7 | 161.6 | −3 | 1 | 1 | 3 |

### Embodiment 9

In this embodiment, a combination of dither matrices shown in Table 37 is employed in an image forming apparatus having the same configuration as the image forming apparatus of Embodiment 1.

TABLE 37

| | Line | Angle | | | | |
|---|---|---|---|---|---|---|
| No. | [lpi] | [deg.] | a0x | a0y | a1x | a1y |
| 0 | 164.9 | 14.0 | 4 | 1 | −1 | −4 |
| 1 | 172.5 | 71.6 | 1 | 3 | 3 | −2 |
| 2 | 189.7 | 108.4 | −1 | 3 | 3 | 1 |
| 3 | 191.7 | 153.4 | −2 | 1 | 1 | 3 |

### Embodiment 10

In this embodiment, a combination of dither matrices shown in Table 38 is employed in an image forming apparatus having the same configuration as the image forming apparatus of Embodiment 1.

TABLE 38

| | Line | Angle | | | | |
|---|---|---|---|---|---|---|
| No. | [lpi] | [deg.] | a0x | a0y | a1x | a1y |
| 0 | 158.1 | 18.4 | 3 | 1 | 0 | −4 |
| 1 | 158.1 | 71.6 | 1 | 3 | 4 | 0 |
| 2 | 189.7 | 108.4 | −1 | 3 | 3 | 1 |
| 3 | 189.7 | 161.6 | −3 | 1 | 1 | 3 |

### Embodiment 11

In this embodiment, a combination of dither matrices shown in Table 39 is employed in an image forming apparatus having the same configuration as the image forming apparatus of Embodiment 1.

TABLE 39

| | Line | Angle | | | | |
|---|---|---|---|---|---|---|
| No. | [lpi] | [deg.] | a0x | a0y | a1x | a1y |
| 0 | 214.3 | 36.9 | 4 | 3 | 4 | −4 |
| 1 | 214.3 | 126.9 | −3 | 4 | 4 | 4 |
| 2 | 215.1 | 76.0 | 1 | 4 | 5 | −3 |
| 3 | 215.1 | 166.0 | −4 | 1 | 3 | 5 |

### Embodiment 12

In this embodiment, a combination of dither matrices shown in Table 40 is employed in an image forming apparatus having the same configuration as the image forming apparatus of Embodiment 1.

TABLE 40

| | Line | Angle | | | | |
|---|---|---|---|---|---|---|
| No. | [lpi] | [deg.] | a0x | a0y | a1x | a1y |
| 0 | 212.0 | 31.0 | 5 | 3 | 1 | −6 |
| 1 | 212.0 | 121.0 | −3 | 5 | 6 | 1 |
| 2 | 215.4 | 68.2 | 2 | 5 | 6 | 0 |
| 3 | 215.4 | 158.2 | −5 | 2 | 0 | 6 |

### Embodiment 13

In this embodiment, a combination of dither matrices shown in Table 41 is employed in an image forming apparatus having the same configuration as the image forming apparatus of Embodiment 1.

TABLE 41

| | Line | Angle | | | | |
|---|---|---|---|---|---|---|
| No. | [lpi] | [deg.] | a0x | a0y | a1x | a1y |
| 0 | 208.5 | 21.8 | 5 | 2 | 3 | −5 |
| 1 | 212.0 | 59.0 | 3 | 5 | 6 | −1 |
| 2 | 212.0 | 149.0 | −5 | 3 | 1 | 6 |
| 3 | 215.4 | 111.8 | −2 | 5 | 6 | 0 |

### Embodiment 14

In this embodiment, a combination of dither matrices shown in Table 42 is employed in an image forming apparatus having the same configuration as the image forming apparatus of Embodiment 1.

TABLE 42

| | Line | Angle | | | | |
|---|---|---|---|---|---|---|
| No. | [lpi] | [deg.] | a0x | a0y | a1x | a1y |
| 0 | 210.8 | 18.4 | 3 | 1 | 3 | −5 |
| 1 | 210.8 | 71.6 | 1 | 3 | 5 | −3 |
| 2 | 210.8 | 108.4 | −1 | 3 | 5 | 3 |
| 3 | 210.8 | 161.6 | −3 | 1 | 3 | 5 |

### Embodiment 15

In this embodiment, a combination of dither matrices shown in Table 43 is employed in an image forming apparatus having the same configuration as the image forming apparatus of Embodiment 1.

TABLE 43

| | Line | Angle | | | | |
|---|---|---|---|---|---|---|
| No. | [lpi] | [deg.] | a0x | a0y | a1x | a1y |
| 0 | 215.1 | 14.0 | 4 | 1 | 3 | −5 |
| 1 | 215.1 | 104.0 | −1 | 4 | 5 | 3 |
| 2 | 215.4 | 68.2 | 2 | 5 | 6 | 0 |
| 3 | 215.4 | 158.2 | −5 | 2 | 0 | 6 |

### Embodiment 16

In this embodiment, a combination of dither matrices shown in Table 44 is employed in an image forming apparatus having the same configuration as the image forming apparatus of Embodiment 1.

TABLE 44

| | Line | Angle | | | | |
|---|---|---|---|---|---|---|
| No. | [lpi] | [deg.] | a0x | a0y | a1x | a1y |
| 0 | 149.9 | 14.0 | 4 | 1 | 1 | −8 |
| 1 | 149.9 | 104.0 | −1 | 4 | 8 | 1 |
| 2 | 212.0 | 59.0 | 3 | 5 | 6 | −1 |
| 3 | 212.0 | 149.0 | −5 | 3 | 1 | 6 |

### Embodiment 17

In this embodiment, a combination of dither matrices shown in Table 45 is employed in an image forming apparatus having the same configuration as the image forming apparatus of Embodiment 1.

TABLE 45

| | Line | Angle | | | | |
|---|---|---|---|---|---|---|
| No. | [lpi] | [deg.] | a0x | a0y | a1x | a1y |
| 0 | 151.5 | 8.1 | 7 | 1 | 0 | −8 |
| 1 | 151.5 | 98.1 | −1 | 7 | 8 | 0 |
| 2 | 214.3 | 53.1 | 3 | 4 | 4 | −4 |
| 3 | 214.3 | 143.1 | −4 | 3 | 4 | 4 |

### Embodiment 18

In this embodiment, a combination of dither matrices shown in Table 46 is employed in an image forming apparatus having the same configuration as the image forming apparatus of Embodiment 1.

TABLE 46

| | Line | Angle | | | | |
|---|---|---|---|---|---|---|
| No. | [lpi] | [deg.] | a0x | a0y | a1x | a1y |
| 0 | 151.8 | 35.5 | 7 | 5 | 8 | −4 |
| 1 | 151.8 | 125.5 | −5 | 7 | 4 | 8 |
| 2 | 214.7 | 80.5 | 1 | 6 | 6 | 2 |
| 3 | 214.7 | 170.5 | −6 | 1 | −2 | 6 |

### Embodiment 19

In this embodiment, a combination of dither matrices shown in Table 47 is employed in an image forming apparatus having the same configuration as the image forming apparatus of Embodiment 1.

TABLE 47

| | Line | Angle | | | | |
|---|---|---|---|---|---|---|
| No. | [lpi] | [deg.] | a0x | a0y | a1x | a1y |
| 0 | 152.1 | 31.0 | 5 | 3 | 2 | −8 |
| 1 | 152.1 | 121.0 | −3 | 5 | 8 | 2 |
| 2 | 215.1 | 76.0 | 1 | 4 | 5 | −3 |
| 3 | 215.1 | 166.0 | −4 | 1 | 3 | 5 |

### Embodiment 20

In this embodiment, a combination of dither matrices shown in Table 48 is employed in an image forming apparatus having the same configuration as the image forming apparatus of Embodiment 1.

TABLE 48

| | Line | Angle | | | | |
|---|---|---|---|---|---|---|
| No. | [lpi] | [deg.] | a0x | a0y | a1x | a1y |
| 0 | 152.3 | 23.2 | 7 | 3 | 6 | −6 |
| 1 | 152.3 | 113.2 | −3 | 7 | 6 | 6 |
| 2 | 215.4 | 68.2 | 2 | 5 | 6 | 0 |
| 3 | 215.4 | 158.2 | −5 | 2 | 0 | 6 |

Table 49 shows color moire scores of the dither sets employed in Embodiment 2-20 calculated with the method described in Embodiment 1.

TABLE 49

| | | Dither set color |
|---|---|---|
| Embodiment No. | Table No. | moire score |
| Embodiment 2 | Table 29 | 0.0112 |
| Embodiment 3 | Table 31 | 0.0112 |
| Embodiment 4 | Table 32 | 0.0116 |
| Embodiment 5 | Table 33 | 0.0125 |
| Embodiment 6 | Table 34 | 0.0133 |
| Embodiment 7 | Table 35 | 0.0133 |
| Embodiment 8 | Table 36 | 0.0134 |
| Embodiment 9 | Table 37 | 0.0134 |
| Embodiment 10 | Table 38 | 0.0141 |
| Embodiment 11 | Table 39 | 0.0072 |
| Embodiment 12 | Table 40 | 0.0073 |
| Embodiment 13 | Table 41 | 0.0074 |
| Embodiment 14 | Table 42 | 0.0076 |
| Embodiment 15 | Table 43 | 0.0078 |
| Embodiment 16 | Table 44 | 0.0081 |
| Embodiment 17 | Table 45 | 0.0081 |
| Embodiment 18 | Table 46 | 0.0081 |
| Embodiment 19 | Table 47 | 0.0081 |
| Embodiment 20 | Table 48 | 0.0081 |

In Embodiments 2-20, the respective CMYK dither matrix combinations are employed to prevent occurrence of visible color moire in the secondary and tertiary colors. As the color moire score value of the dither sets of Embodiments 2-20 ranges 0.0072-0.0142, which is considered as very preferable (low), color moire is hardly perceived on an output image.

The following describes a method for selecting the dither sets (combination of four dithers corresponding to four colors of CMYK) used in Embodiments 1-10 and 11-20

In Embodiments 1-10, dither sets having a resolution of 600 dpi are employed. In the case of the resolution of 600 dpi, 44 dither matrices (line screen dither matrices) with a periodic structure having equal to or greater than 150 lpi (the number of screen lines) but less than or equal to 220 lpi are found (the number of screen lines that can be actually used in image forming on a hard copy is considered to be in a range equal to or greater than 150 lpi but less than or equal to 220 lpi). In other words, there are found 44 combinations of a main vector and a sub vector of which the number of screen lines calculated by the formula shown in FIG. 3 is equal to or greater than 150 lpi but less than or equal to 220 lpi.

With these 44 matrices, about 130,000 (to be exact, 135,751) dither matrix sets (combinations of four dither matrices) can be formed. Color moire scores of all of the about 130,000 combinations were calculated with the calculation method described above, and the dither sets having low color moire scores are employed in Embodiments 1-10.

In Embodiments 11-20, dither sets having a resolution of 1200 dpi are employed. In the case of the resolution of 1,200 dpi, 614 dither matrices (line screen dither matrices) with a periodic structure having equal to or greater than 150 lpi but less than or equal to 220 lpi are found. In other words, there are found 614 combinations of a main vector and a sub vector of which the number of screen lines calculated by the formula shown in FIG. 3 is equal to or greater than 150 lpi and less than or equal to 220 lpi.

Therefore, 44 dither matrices with a resolution of 600 dpi and 614 dither matrices with a resolution of 1,200 dpi are stored in the dither matrix storage 2.

With these 614 matrices, about 5.9 billion (to be exact, 5,864,219,751) dither matrix sets (combinations of four dither matrices) can be formed. Color moire scores of all of the about 5.9 billion combinations were calculated with the calculation method described above, and the dither sets having low color moire scores are employed in Embodiments 11-20.

### Comparative Experiment 1

The following describes a comparative experiment. In these experiments, above-described dither matrix sets having different color moire scores were prepared. Color moire in images output from a test machine using these dither matrix sets was evaluated with human vision.

Ispio Color 5100 (from Ricoh Company, Ltd.) that can output dithered images was altered to be used as a test machine for image output experiments. This test machine can switch the resolution between 600 dpi for writing 8 bits per pixel and 1,200 dpi for writing 4 bits per pixel. As the polymerized toner of Embodiment 1 was used, a fixing unit was employed that includes a heating belt and a pressure roller both coated with a fluorocarbon resin layer.

The dither matrix sets (combinations of

CMYK dither matrices) used in the comparative experiments are shown in Table 50, Table 51, Table 52 (Comparative Example 1), Table 53 (Comparative Example 2), and Table 54 (Comparative Example 3).

TABLE 50

| | Line | Angle | | | | |
|---|---|---|---|---|---|---|
| No. | [lpi] | [deg.] | a0x | a0y | a1x | a1y |
| 0 | 167.7 | 26.6 | 2 | 1 | 2 | −3 |
| 1 | 172.5 | 161.6 | −3 | 1 | 2 | 3 |
| 2 | 189.7 | 71.6 | 1 | 3 | 3 | −1 |
| 3 | 189.7 | 108.4 | −1 | 3 | 3 | 1 |

TABLE 51

| | Line | Angle | | | | |
|---|---|---|---|---|---|---|
| No. | [lpi] | [deg.] | a0x | a0y | a1x | a1y |
| 0 | 158.1 | 18.4 | 3 | 1 | 0 | −4 |
| 1 | 180.3 | 56.3 | 2 | 3 | 2 | −3 |
| 2 | 180.3 | 146.3 | −3 | 2 | 3 | 2 |
| 3 | 189.7 | 108.4 | −1 | 3 | 3 | 1 |

TABLE 52

| No. | Line [lpi] | Angle [deg.] | a0x | a0y | a1x | a1y |
|---|---|---|---|---|---|---|
| 0 | 166.4 | 33.7 | 3 | 2 | 2 | −3 |
| 1 | 167.7 | 153.4 | −2 | 1 | 2 | 3 |
| 2 | 172.5 | 71.6 | 1 | 3 | 3 | −2 |
| 3 | 191.7 | 116.6 | −1 | 2 | 3 | 1 |

TABLE 53

| No. | Line [lpi] | Angle [deg.] | a0x | a0y | a1x | a1y |
|---|---|---|---|---|---|---|
| 0 | 158.1 | 18.4 | 3 | 1 | 0 | −4 |
| 1 | 172.5 | 161.6 | −3 | 1 | 2 | 3 |
| 2 | 180.3 | 56.3 | 2 | 3 | 2 | −3 |
| 3 | 180.3 | 123.7 | −2 | 3 | 2 | 3 |

TABLE 54

| No. | Line [lpi] | Angle [deg.] | a0x | a0y | a1x | a1y |
|---|---|---|---|---|---|---|
| 0 | 167.7 | 26.2 | 2 | 1 | 2 | −3 |
| 1 | 172.5 | 161.6 | −3 | 1 | 2 | 3 |
| 2 | 191.7 | 63.4 | 1 | 2 | 3 | −1 |
| 3 | 191.7 | 116.6 | −1 | 2 | 3 | 1 |

Calculated color moire scores and evaluation of output images are shown in Table 55. The output images, including gray-scale images containing four tertiary colors and SCID images (S9, S10, N3A), were evaluated with eyes.

TABLE 55

| | Dither set | |
|---|---|---|
| Table | color | |
| No. | moire score | Evaluation |
| Table 50 | 0.0140 | ◯ Color moire not recognized in secondary |
| | | and tertiary colors |
| Table 51 | 0.0150 | ◯ Color moire not recognized in secondary |
| | | and tertiary colors |
| Table 52 | 0.0159 | Δ A little color moire recognized in secondary |
| | | color (0th-2nd colors) |
| Table 53 | 0.0173 | X Color moire recognized in secondary color |
| | | (0th-1nd colors) |
| Table 54 | 0.0200 | X Color moire recognized in secondary color |
| | | (0th-2nd-3rd colors) |

As can be seen from the result, using a dither matrix set including dither matrices of a color moire score of 0.015 or lower can realize an image forming apparatus capable of producing high-quality images while preventing occurrence of color moire due to superpositions of toner images.

On the other hand, when the color moire score exceeds 0.015, color moire occurs in a color formed by combinations of colors including Y. Therefore, it becomes difficult to produce high-quality images.

### Comparative Experiment 2

In Comparative Experiment 2, relationship between toner components and color moire that occurs between Y and the other CMK colors was examined. Toners containing different waxes (release agents) were prepared for the color moire evaluation. In this experiment, a pattern having an angle difference of 20 degrees between Y and the other CMK colors was prepared for image outputting. Output images were evaluated with eyes.

TABLE 56

| Toner (wax type, production method) | Color moire between Y and CMK |
|---|---|
| synthetic ester wax, emulsion | X Color moire recognized |
| polymerization | |
| carnauba wax, emulsion | X Color moire recognized |
| polymerization | |
| synthetic ester wax, milling | X Color moire recognized |
| no wax, milling | ◯ Color moire hardly recognized |
| | with eyes |
| no wax, polymerization | Δ A little color moire recognized |

As can be seen from Table 56, when wax release agent was contained in the toner component, color moire was caused between Y and the other CMK colors. From the result of this comparative experiment, it is presumed that the presence of wax components in the toner causes Y to affect (impair) toner color development of the other colors, thereby causing color moire.

It is also found from the result of this experiment that the color moire related to Y varies depending on a toner production method. The color moire related to Y was more likely to occur with use of a toner produced by a polymerization method compared to a toner produced by a milling method, which is widely used. Accordingly, a dither matrix combination capable of preventing color moire that occurs between Y and the other CMK colors is effective when polymerized toners (containing no release agent) are used.

### Embodiment 21

An image forming apparatus of Embodiment 21 is the same as the image forming apparatus of Embodiment 1 except the optical unit. According to Embodiment 21, the optical unit of Embodiment 1 is replaced by an LED writing system. Compared to the above-described LD system, the LED optical writing system has following advantages: noise is reduced because a driving section such as a polygon mirror is not installed; and the installation space can be saved because the size of the optical system is relatively small.

### Embodiment 22

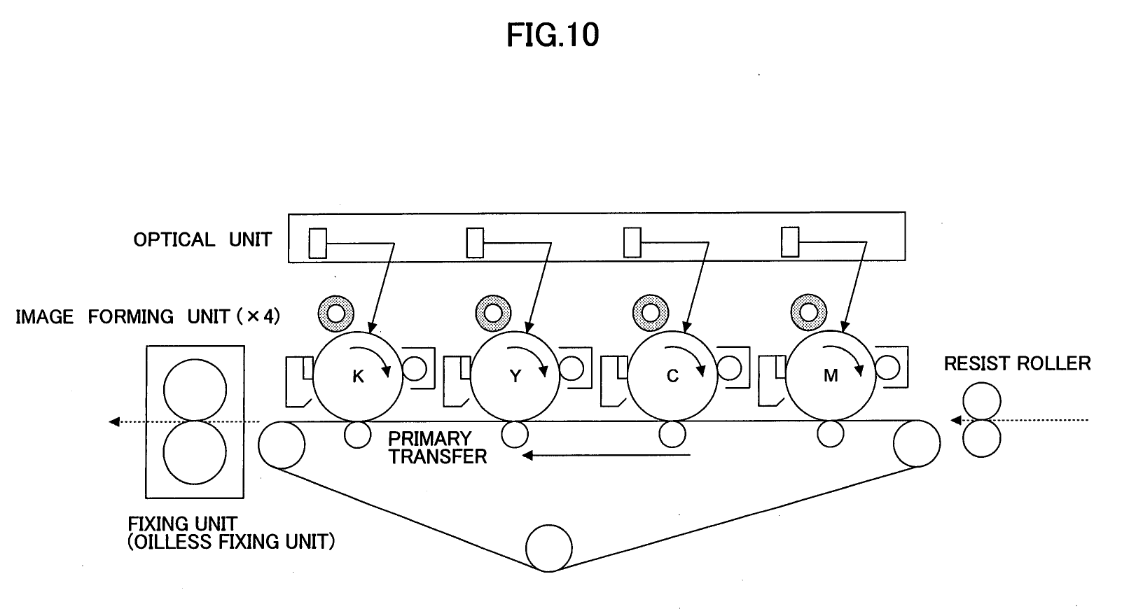

According to Embodiment 22, any one the dither matrix combinations of Embodiment 1-20 is applied to a so-called tandem type (direct transfer) color image forming apparatus. FIG. 10 illustrates the configuration of Embodiment 22.

### Embodiment 23

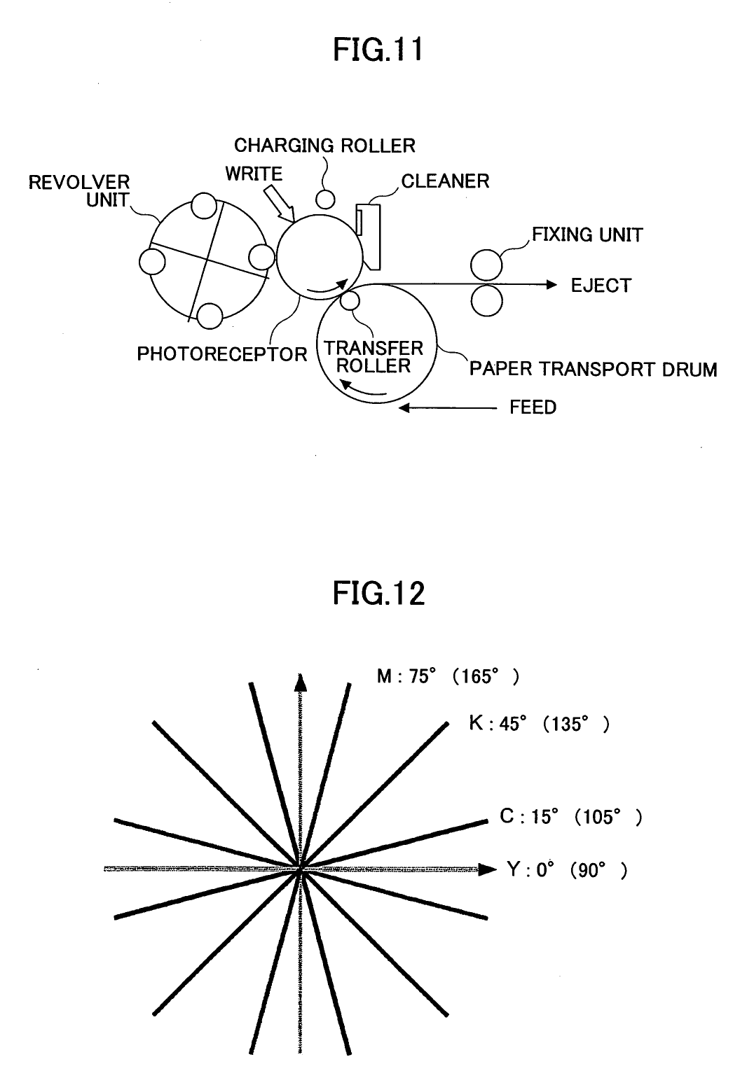

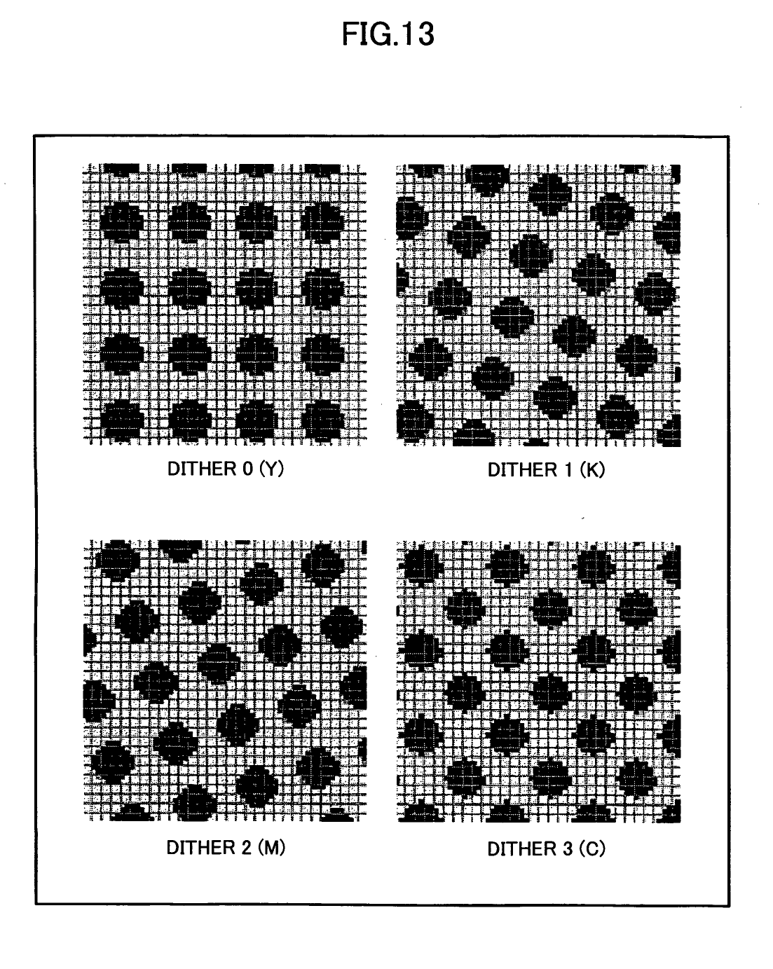

According to Embodiment 23, any one the dither matrix combinations of Embodiment 1-20 is applied to a so-called revolver type color image forming apparatus. FIG. 11 illustrates the configuration of Embodiment 23.

### Embodiment 24

While the electrophotographic image forming apparatus is exemplified in the above description, the present invention is not limited to the specific embodiments described above. For instance, an offset printing image forming apparatus (printing machine) in which one of the dither matrix combinations of Embodiment 1-20 is used for dithering (half-tone dot meshing) of CMYK colors can achieve the same effects and advantages.

The present invention is also realized by providing a recording medium storing program codes of software that realize the processing procedures and functions of the above-described embodiments in a system or a device, and causing a computer (CPU or MPU) of the system or the device to read and execute the program codes stored in the recording medium. In this case, the program codes read from the recording medium realize the processing procedures and functions of the above-described embodiments. The recording medium for providing the program codes may include, for example, flexible disks, hard disks, optical discs, magneto-optical disks, magnetic tapes, nonvolatile memory cards, and ROMs. The present invention includes not only execution of the procedures of the above-described embodiments by execution of program codes read by a computer, but also execution of the functions of the above-described embodiments by a part or all of the operations performed by an operating system running on computers according to commands of the program codes. The present invention further includes cases where program codes read from a recording medium are written in a memory of a function enhancement board inserted in a computer or provided in a function enhancement unit connected to a computer, and a CPU of the function enhancement board or the function enhancement unit performs a part or all of the operations according to commands of the program codes, thereby executing the functions of the above-described embodiments.

According to the above-described embodiments of the present invention, the following advantages can be achieved.

Since there are numerous combinations (several tens of thousands through billions of combinations) of dither matrices having linear periodic structures, it is impractical to randomly form combinations and find a dither matrix set with reduced color moire. Therefore, a combination of CMYK dither matrices (a dither set) known to have reduced moire based on experience can be used.

With the method described in Embodiment 1, it is possible to determine a dither set that reduces color moire. Specifically, dither sets that satisfy the conditional expressions provided in Embodiment 1 make color moire in secondary and tertiary colors hardly recognizable. With the method described in Embodiment 1, because the time taken to perform calculation for evaluating and determining dither sets is very short (it took several tens of seconds to perform calculation for evaluating several tens of thousands of dither sets in a calculation environment of the inventor), it becomes possible to evaluate and rank the numerous combinations.

A dither set comprising line screen dither matrices that have linear periodic structures has a unique characteristic in that tertiary color moire becomes highly visible. Therefore, prevention of tertiary color moire needs to be taken into consideration when combining line screen dither matrices. The image forming apparatus according to Embodiment 1 can make such tertiary color moire invisible.

As the image forming apparatuses of the above-described embodiments have the dither sets that are formed in accordance with a result of such a consideration, they can reduce color moire in all the secondary and tertiary colors that are created by a combination of CMYK toner images.

Electrophotographic image forming apparatuses make color moire that occurs due to superposition of a Y toner image and CMK toner images more visible than printing systems. Such color moire in electrophotography cannot be eliminated by existing methods of combining dither matrices (i.e., the method of combining dot screen dither matrices and setting the screen angles of Y 15 degrees apart from C and M, which are described in “BACKGROUND OF THE INVENTION”), and therefore prevents high-quality image output.

According to the above-described embodiments, as the line screens having line structures are employed, directional axes of the four colors of CMYK are allowed to be set within in a range of 180 degrees. Therefore, reduction of color moire in output images that are not achieved by dot screens can be realized. Color moire that occurs between Y patterns and CMK patterns can be eliminated, and color moire that occurs among CMK patterns can also be reduced.

As can be seen from the results of the experiments performed by the inventor, the image forming apparatuses provided according to the above-described embodiments can solve the problems mentioned in the above description. More specifically, the image forming apparatuses provided according to the embodiments can output images in which both color moire that occurs between Y and CMK, which is specific to electrophotographic image forming apparatuses, and color moire that occurs among other colors are made invisible.

As can be seen from the results of the experiments performed by the inventor, image forming apparatuses using a toner produced by a polymerization method make the color moire that occurs due to the superposition of the Y toner image and the CMK toner images more visible than image forming apparatuses using a toner produced by a milling method, and prevent high-quality image output.

A polymerization method can produce a toner having a small volume-average particle diameter (up to about 5 μm) more easily than a milling method. Use of a toner having a small volume-average particle diameter can output images with better graininess. The graininess is an index that represents image roughness. Images with a good graininess are low in noise and are more continuous. The polymerization method compared to the milling method can reduce energy required in toner production.

It has been impossible to achieve improvement of image quality (improvement of graininess) and energy savings with the use of a toner produced by the polymerization method, together with elimination of color moire that occurs due to superposition of a Y toner image with CMK toner images.

The image forming apparatuses of the above-described embodiments can solve this problem. Specifically, the spatial frequency of the color moire that occurs between Y and CMK can be set to a frequency high enough to make the color moire that occurs due to the use of a toner produced by the polymerization method invisible. Therefore, even when a toner produced by the polymerization method is used, the color moire related to Y is prevented (the reason of the occurrence of the color moire due to the use of the toner produced by the polymerization method is described in “BACKGROUND OF THE INVENTION”).

According to the above embodiments, color moire that occurs in the secondary and tertiary colors of the CMYK toner images produced by the polymerization method are made invisible. Therefore, an image forming apparatus capable of preventing not only color moire that occurs among CMK and but also color moire that occurs between Y and CMK can be realized.

In image forming apparatuses that uses a wax release agent, color moire often occurs due to superposition of a Y toner image and other CMK toner images, and prevents high-quality image output.

However, when images are output using a toner containing a wax release agent, an oilless fixing unit that does not require application of oil to a heating roller can be used. As the oilless fixing unit does not require application of oil and therefore is easy to be maintained, the configuration and mechanism of the fixing unit can be simplified. The oilless fixing unit is also advantageous as it does not consume oil. These advantages contribute to size reduction and cost reduction of the image forming apparatus.

In short, when an oilless fixing method using a toner containing a wax release agent is employed, color moire that often occurs due to superposition of a Y toner image with CMK toner images can not be eliminated.

The image forming apparatuses according to the above-described embodiments can solve this problem. Specifically, the image forming apparatuses can output images in which both color moire that occurs between Y and CMK and the color moire that occurs among CMK are invisible event when a toner containing a wax release agent is used.

According to the above-described embodiments, there are provided image forming apparatuses having combinations of dither matrices that greatly reduce color moire in the four colors of CMYK at a resolution of 600 dpi. As the resolution is 600 dpi, there is no need to have an optical writing system having a high resolution (1200 dpi, 2,400 dpi, etc.) and an electronic circuit that realizes a high pixel clock. Therefore, low-cost and small-size image forming apparatuses that can eliminate color moire of the four colors of CMYK are realized.

According to the above-described embodiments, there are also provided image forming apparatuses having combinations of dither matrices that reduce color moire in the four colors of CMYK at a resolution of 600 dpi. When the resolution is 1200 dpi, as freedom of writing position is increased, more combinations of dither matrices are available. According to above embodiments, more combinations of dither matrices are available, a combination of dither matrices having a low color moire score (0.0072-0.0082) is provided and offers beneficial effects as described above.

The present application is based on

Japanese Priority Application No. 2004-285757 filed on Sep. 30, 2004, with the Japanese Patent Office, the entire contents of which are hereby incorporated by reference.

What is claimed is:

1. An image forming apparatus that superposes color material images of four colors of cyan, magenta, yellow and black on a predetermined medium using color materials of the four colors,
wherein each of the color material images of the four colors has a linear periodic structure represented by a function whose reflectance distribution formed by periodic adhesion of a corresponding color material is normalized at 1.0;
when an intensity and a spatial frequency of a beat calculated by multiplication of each of combinations of spatial frequency components between two functions corresponding to two of the four colors are defined as P2i and f2i (suffix i identifying each of the combinations of the spatial frequency components between the two colors), respectively, a relational expression P2i·VTF(f2i)≦0.015 (VTF(f) representing a visual transfer function) is satisfied by each of six combinations of two colors selected from the four colors; and
when the intensity and the spatial frequency of a beat calculated by multiplication of each of combinations of spatial frequency components among three functions corresponding to three of the four colors are defined as P3j and f3j (the suffix j identifying each of the combinations of the spatial frequency components among the three colors), respectively, a relational expression P3j·VTF(f3j)≦0.015 is satisfied by each of four combinations of three colors selected from the four colors.

2. An electrophotographic image forming apparatus that superposes toner images of four colors of cyan, magenta, yellow and black on a predetermined medium using power toners of the four colors,
wherein each of the toner images of the four colors has a linear periodic structure represented by a function whose reflectance distribution formed by periodic adhesion of a corresponding toner is normalized at 1.0;
when an intensity and a spatial frequency of a beat calculated by multiplication of each of combinations of spatial frequency components between the two functions corresponding to two of the four colors are defined as P2i and f2i (suffix i identifying each of the combinations of the spatial frequency components between the two colors), respectively, a relational expression P2i·VTF(f2i)≦0.015 (VTF(f) representing a visual transfer function) is satisfied by each of six combinations of two colors selected from the four colors; and
when the intensity and the spatial frequency of a beat calculated by multiplication of each of combinations of spatial frequency components among three functions corresponding to three of the four colors are defined as P3j and f3j (the suffix j identifying each of the combinations of the spatial frequency components among the three colors), respectively, a relational expression P3j·VTF(f3j)≦0.015 is satisfied by each of four combinations of three colors selected from the four colors.

3. The image forming apparatus as claimed in claim 2, wherein the toners of the four colors are produced by a polymerization method.

4. The image forming apparatus as claimed in claim 2, wherein the toners of the four colors each contains a wax release agent.

5. The image forming apparatus as claimed in claim 2, wherein the linear periodic structures of the toner images of the four colors are formed by a combination of periodic structures having the number of screen lines and screen angles specified in Table 1:
TABLE 1

| No. | Line [lpi] | Angle [deg.] | a0x | a0y | a1x | a1y |
|---|---|---|---|---|---|---|
| 0 | 150.0 | 0.0 | 1 | 0 | 0 | −4 |
| 1 | 150.0 | 90.0 | 0 | 1 | 4 | 0 |
| 2 | 212.1 | 45.0 | 1 | 1 | 2 | −2 |
| 3 | 212.1 | 135.0 | −1 | 1 | 2 | 2 |

in which a0x, a0y, a1x, and a1y represent an x component and a y component of a main vector and an x component and a y component of a sub vector, respectively.

6. The image forming apparatus as claimed in claim 2, wherein the linear periodic structures of the toner images of the four colors are formed by a combination of periodic structures having the number of screen lines and screen angles specified in Table 2:
TABLE 2

| No. | Line [lpi] | Angle [deg.] | a0x | a0y | a1x | a1y |
|---|---|---|---|---|---|---|
| 0 | 191.7 | 26.6 | 2 | 1 | 1 | −3 |
| 1 | 191.7 | 63.4 | 1 | 2 | 3 | −1 |
| 2 | 191.7 | 116.6 | −1 | 2 | 3 | 1 |
| 3 | 191.7 | 153.4 | −2 | 1 | 1 | 3 |

in which a0x, a0y, a1x, and a1y represent an x component and a y component of a main vector and an x component and a y component of a sub vector, respectively.

7. The image forming apparatus as claimed in claim 2, wherein the linear periodic structures of the toner images of the four colors are formed by a combination of periodic structures having the number of screen lines and screen angles specified in Table 3:
TABLE 3

| No. | Line [lpi] | Angle [deg.] | a0x | a0y | a1x | a1y |
|---|---|---|---|---|---|---|
| 0 | 189.7 | 18.4 | 3 | 1 | 1 | −3 |
| 1 | 189.7 | 108.4 | −1 | 3 | 3 | 1 |
| 2 | 191.7 | 63.4 | 1 | 2 | 3 | −1 |
| 3 | 191.7 | 153.4 | −2 | 1 | 1 | 3 |

in which a0x, a0y, a1x, and a1y represent an x component and a y component of a main vector and an x component and a y component of a sub vector, respectively.

8. The image forming apparatus as claimed in claim 2, wherein the linear periodic structures of the toner images of the four colors are formed by a combination of periodic structures having the number of screen lines and screen angles specified in Table 4:
TABLE 4

| No. | Line [lpi] | Angle [deg.] | a0x | a0y | a1x | a1y |
|---|---|---|---|---|---|---|
| 0 | 189.7 | 18.4 | 3 | 1 | 1 | −3 |
| 1 | 189.7 | 71.6 | 1 | 3 | 3 | −1 |
| 2 | 189.7 | 108.4 | −1 | 3 | 3 | 1 |
| 3 | 189.7 | 161.6 | −3 | 1 | 1 | 3 |

in which a0x, a0y, a1x, and a1y represent an x component and a y component of a main vector and an x component and a y component of a sub vector, respectively.

9. The image forming apparatus as claimed in claim 2, wherein the linear periodic structures of the toner images of the four colors are formed by a combination of periodic structures having the number of screen lines and screen angles specified in Table 5:
TABLE 5

| No. | Line [lpi] | Angle [deg.] | a0x | a0y | a1x | a1y |
|---|---|---|---|---|---|---|
| 0 | 158.1 | 18.4 | 3 | 1 | 0 | −4 |
| 1 | 158.1 | 71.6 | 1 | 3 | 4 | 0 |
| 2 | 191.7 | 116.6 | −1 | 2 | 3 | 1 |
| 3 | 191.7 | 153.4 | −2 | 1 | 1 | 3 |

in which a0x, a0y, a1x, and a1y represent an x component and a y component of a main vector and an x component and a y component of a sub vector, respectively.

10. The image forming apparatus as claimed in claim 2, wherein the linear periodic structures of the toner images of the four colors are formed by a combination of periodic structures having the number of screen lines and screen angles specified in Table 6:
TABLE 6

| No. | Line [lpi] | Angle [deg.] | a0x | a0y | a1x | a1y |
|---|---|---|---|---|---|---|
| 0 | 167.7 | 26.6 | 2 | 1 | 2 | −3 |
| 1 | 167.7 | 153.4 | −2 | 1 | 2 | 3 |
| 2 | 191.7 | 63.4 | 1 | 2 | 3 | −1 |
| 3 | 191.7 | 116.6 | −1 | 2 | 3 | 1 |

in which a0x, a0y, a1x, and a1y represent an x component and a y component of a main vector and an x component and a y component of a sub vector, respectively.

11. The image forming apparatus as claimed in claim 2, wherein the linear periodic structures of the toner images of the four colors are formed by a combination of periodic structures having the number of screen lines and screen angles specified in Table 7:
TABLE 7

| No. | Line [lpi] | Angle [deg.] | a0x | a0y | a1x | a1y |
|---|---|---|---|---|---|---|
| 0 | 166.4 | 33.7 | 3 | 2 | 2 | −3 |
| 1 | 167.7 | 153.4 | −2 | 1 | 2 | 3 |
| 2 | 189.7 | 71.6 | 1 | 3 | 3 | −1 |
| 3 | 191.7 | 116.6 | −1 | 2 | 3 | 1 |

in which a0x, a0y, a1x, and a1y represent an x component and a y component of a main vector and an x component and a y component of a sub vector, respectively.

12. The image forming apparatus as claimed in claim 2, wherein the linear periodic structures of the toner images of the four colors are formed by a combination of periodic structures having the number of screen lines and screen angles specified in Table 8:
TABLE 8

| | Line | Angle | | | | |
|---|---|---|---|---|---|---|
| No. | [lpi] | [deg.] | a0x | a0y | a1x | a1y |
| 0 | 172.5 | 18.4 | 3 | 1 | 2 | −3 |
| 1 | 172.5 | 71.6 | 1 | 3 | 3 | −2 |
| 2 | 189.7 | 108.4 | −1 | 3 | 3 | 1 |
| 3 | 189.7 | 161.6 | −3 | 1 | 1 | 3 |

in which a0x, a0y, a1x, and a1y represent an x component and a y component of a main vector and an x component and a y component of a sub vector, respectively.

13. The image forming apparatus as claimed in claim 2, wherein the linear periodic structures of the toner images of the four colors are formed by a combination of periodic structures having the number of screen lines and screen angles specified in Table 9:
TABLE 9

| | Line | Angle | | | | |
|---|---|---|---|---|---|---|
| No. | [lpi] | [deg.] | a0x | a0y | a1x | a1y |
| 0 | 164.9 | 14.0 | 4 | 1 | −1 | −4 |
| 1 | 172.5 | 71.6 | 1 | 3 | 3 | −2 |
| 2 | 189.7 | 108.4 | −1 | 3 | 3 | 1 |
| 3 | 191.7 | 153.4 | −2 | 1 | 1 | 3 |

in which a0x, a0y, a1x, and a1y represent an x component and a y component of a main vector and an x component and a y component of a sub vector, respectively.

14. The image forming apparatus as claimed in claim 2, wherein the linear periodic structures of the toner images of the four colors are formed by a combination of periodic structures having the number of screen lines and screen angles specified in Table 10:
TABLE 10

| | Line | Angle | | | | |
|---|---|---|---|---|---|---|
| No. | [lpi] | [deg.] | a0x | a0y | a1x | a1y |
| 0 | 158.1 | 18.4 | 3 | 1 | 0 | −4 |
| 1 | 158.1 | 71.6 | 1 | 3 | 4 | 0 |
| 2 | 189.7 | 108.4 | −1 | 3 | 3 | 1 |
| 3 | 189.7 | 161.6 | −3 | 1 | 1 | 3 |

in which a0x, a0y, a1x, and a1y represent an x component and a y component of a main vector and an x component and a y component of a sub vector, respectively.

15. The image forming apparatus as claimed in claim 2, wherein the linear periodic structures of the toner images of the four colors are formed by a combination of periodic structures having the number of screen lines and screen angles specified in Table 11:
TABLE 11

| | Line | Angle | | | | |
|---|---|---|---|---|---|---|
| No. | [lpi] | [deg.] | a0x | a0y | a1x | a1y |
| 0 | 214.3 | 36.9 | 4 | 3 | 4 | −4 |
| 1 | 214.3 | 126.9 | −3 | 4 | 4 | 4 |
| 2 | 215.1 | 76.0 | 1 | 4 | 5 | −3 |
| 3 | 215.1 | 166.0 | −4 | 1 | 3 | 5 |

in which a0x, a0y, a1x, and a1y represent an x component and a y component of a main vector and an x component and a y component of a sub vector, respectively.

16. The image forming apparatus as claimed in claim 2, wherein the linear periodic structures of the toner images of the four colors are formed by a combination of periodic structures having the number of screen lines and screen angles specified in Table 12:
TABLE 12

| | Line | Angle | | | | |
|---|---|---|---|---|---|---|
| No. | [lpi] | [deg.] | a0x | a0y | a1x | a1y |
| 0 | 212.0 | 31.0 | 5 | 3 | 1 | −6 |
| 1 | 212.0 | 121.0 | −3 | 5 | 6 | 1 |
| 2 | 215.4 | 68.2 | 2 | 5 | 6 | 0 |
| 3 | 215.4 | 158.2 | −5 | 2 | 0 | 6 |

in which a0x, a0y, a1x, and a1y represent an x component and a y component of a main vector and an x component and a y component of a sub vector, respectively.

17. The image forming apparatus as claimed in claim 2, wherein the linear periodic structures of the toner images of the four colors are formed by a combination of periodic structures having the number of screen lines and screen angles specified in Table 13:
TABLE 13

| | Line | Angle | | | | |
|---|---|---|---|---|---|---|
| No. | [lpi] | [deg.] | a0x | a0y | a1x | a1y |
| 0 | 208.5 | 21.8 | 5 | 2 | 3 | −5 |
| 1 | 212.0 | 59.0 | 3 | 5 | 6 | −1 |
| 2 | 212.0 | 149.0 | −5 | 3 | 1 | 6 |
| 3 | 215.4 | 111.8 | −2 | 5 | 6 | 0 |

in which a0x, a0y, a1x, and a1y represent an x component and a y component of a main vector and an x component and a y component of a sub vector, respectively.

18. The image forming apparatus as claimed in claim 2, wherein the linear periodic structures of the toner images of the four colors are formed by a combination of periodic structures having the number of screen lines and screen angles specified in Table 14:
TABLE 14

| | Line | Angle | | | | |
|---|---|---|---|---|---|---|
| No. | [lpi] | [deg.] | a0x | a0y | a1x | a1y |
| 0 | 210.8 | 18.4 | 3 | 1 | 3 | −5 |
| 1 | 210.8 | 71.6 | 1 | 3 | 5 | −3 |
| 2 | 210.8 | 108.4 | −1 | 3 | 5 | 3 |
| 3 | 210.8 | 161.6 | −3 | 1 | 3 | 5 |

in which a0x, a0y, a1x, and a1y represent an x component and a y component of a main vector and an x component and a y component of a sub vector, respectively.

19. The image forming apparatus as claimed in claim 2, wherein the linear periodic structures of the toner images of the four colors are formed by a combination of periodic structures having the number of screen lines and screen angles specified in Table 15:
TABLE 15

| | Line | Angle | | | | |
|---|---|---|---|---|---|---|
| No. | [lpi] | [deg.] | a0x | a0y | a1x | a1y |
| 0 | 215.1 | 14.0 | 4 | 1 | 3 | −5 |
| 1 | 215.1 | 104.0 | −1 | 4 | 5 | 3 |
| 2 | 215.4 | 68.2 | 2 | 5 | 6 | 0 |
| 3 | 215.4 | 158.2 | −5 | 2 | 0 | 6 |

in which a0x, a0y, a1x, and a1y represent an x component and a y component of a main vector and an x component and a y component of a sub vector, respectively.

20. The image forming apparatus as claimed in claim 2, wherein the linear periodic structures of the toner images of the four colors are formed by a combination of periodic structures having the number of screen lines and screen angles specified in Table 16:
TABLE 16

| | Line | Angle | | | | |
|---|---|---|---|---|---|---|
| No. | [lpi] | [deg.] | a0x | a0y | a1x | a1y |
| 0 | 149.9 | 14.0 | 4 | 1 | 1 | −8 |
| 1 | 149.9 | 104.0 | −1 | 4 | 8 | 1 |
| 2 | 212.0 | 59.0 | 3 | 5 | 6 | −1 |
| 3 | 212.0 | 149.0 | −5 | 3 | 1 | 6 |

in which a0x, a0y, a1x, and a1y represent an x component and a y component of a main vector and an x component and a y component of a sub vector, respectively.

21. The image forming apparatus as claimed in claim 2, wherein the linear periodic structures of the toner images of the four colors are formed by a combination of periodic structures having the number of screen lines and screen angles specified in Table 17:
TABLE 17

| | Line | Angle | | | | |
|---|---|---|---|---|---|---|
| No. | [lpi] | [deg.] | a0x | a0y | a1x | a1y |
| 0 | 151.5 | 8.1 | 7 | 1 | 0 | −8 |
| 1 | 151.5 | 98.1 | −1 | 7 | 8 | 0 |
| 2 | 214.3 | 53.1 | 3 | 4 | 4 | −4 |
| 3 | 214.3 | 143.1 | −4 | 3 | 4 | 4 |

in which a0x, a0y, a1x, and a1y represent an x component and a y component of a main vector and an x component and a y component of a sub vector, respectively.

22. The image forming apparatus as claimed in claim 2, wherein the linear periodic structures of the toner images of the four colors are formed by a combination of periodic structures having the number of screen lines and screen angles specified in Table 18:
TABLE 18

| No. | Line [lpi] | Angle [deg.] | a0x | a0y | a1x | a1y |
|---|---|---|---|---|---|---|
| 0 | 151.8 | 35.5 | 7 | 5 | 8 | −4 |
| 1 | 151.8 | 125.5 | −5 | 7 | 4 | 8 |
| 2 | 214.7 | 80.5 | 1 | 6 | 6 | 2 |
| 3 | 214.7 | 170.5 | −6 | 1 | −2 | 6 |

in which a0x, a0y, a1x, and a1y represent an x component and a y component of a main vector and an x component and a y component of a sub vector, respectively.

23. The image forming apparatus as claimed in claim 2, wherein the linear periodic structures of the toner images of the four colors are formed by a combination of periodic structures having the number of screen lines and screen angles specified in Table 19:
TABLE 19

| No. | Line [lpi] | Angle [deg.] | a0x | a0y | a1x | a1y |
|---|---|---|---|---|---|---|
| 0 | 152.1 | 31.0 | 5 | 3 | 2 | −8 |
| 1 | 152.1 | 121.0 | −3 | 5 | 8 | 2 |
| 2 | 215.1 | 76.0 | 1 | 4 | 5 | −3 |
| 3 | 215.1 | 166.0 | −4 | 1 | 3 | 5 |

in which a0x, a0y, a1x, and a1y represent an x component and a y component of a main vector and an x component and a y component of a sub vector, respectively.

24. The image forming apparatus as claimed in claim 2, wherein the linear periodic structures of the toner images of the four colors are formed by a combination of periodic structures having the number of screen lines and screen angles specified in Table 20:
TABLE 20

| No. | Line [lpi] | Angle [deg.] | a0x | a0y | a1x | a1y |
|---|---|---|---|---|---|---|
| 0 | 152.3 | 23.2 | 7 | 3 | 6 | −6 |
| 1 | 152.3 | 113.2 | −3 | 7 | 6 | 6 |
| 2 | 215.4 | 68.2 | 2 | 5 | 6 | 0 |
| 3 | 215.4 | 158.2 | −5 | 2 | 0 | 6 |

in which a0x, a0y, a1x, and a1y represent an x component and a y component of a main vector and an x component and a y component of a sub vector, respectively.

25. An image forming method for superposing color material images of four colors of cyan, magenta, yellow and black on a predetermined medium using color materials of the four colors,
wherein each of the color material images of the four colors has a linear periodic structure represented by a function whose reflectance distribution formed by periodic adhesion of a corresponding color material is normalized at 1.0;
when an intensity and a spatial frequency of a beat calculated by multiplication of each of combinations of spatial frequency components between two functions corresponding to two of the four colors are defined as P2i and f2i (suffix i identifying each of the combinations of the spatial frequency components between the two colors), respectively, a relational expression P2i·VTF(f2i)≦0.015 (VTF(f) representing a visual transfer function) is satisfied by each of six combinations of two colors selected from the four colors; and
when the intensity and the spatial frequency of a beat calculated by multiplication of each of combinations of spatial frequency components among three functions corresponding to three of the four colors are defined as P3j and f3j (the suffix j identifying each of the combinations of the spatial frequency components among the three colors), respectively, a relational expression P3j·VTF(f3j)≦0.015 is satisfied by each of four combinations of three colors selected from the four colors.

26. A computer-readable recording medium storing program codes for performing an image forming method for superposing color material images of four colors of cyan, magenta, yellow and black on a predetermined medium using color materials of the four colors,
wherein each of the color material images of the four colors has a linear periodic structure represented by a function whose reflectance distribution formed by periodic adhesion of a corresponding color material is normalized at 1.0;
when an intensity and a spatial frequency of a beat calculated by multiplication of each of combinations of spatial frequency components between two functions corresponding to two of the four colors are defined as P2i and f2i (suffix i identifying each of the combinations of the spatial frequency components between the two colors), respectively, a relational expression P2i·VTF(f2i)≦0.015 (VTF(f) representing a visual transfer function) is satisfied by each of six combinations of two colors selected from the four colors; and
when the intensity and the spatial frequency of a beat calculated by multiplication of each of combinations of spatial frequency components among three functions corresponding to three of the four colors are defined as P3j and f3j (the suffix j identifying each of the combinations of the spatial frequency components among the three colors), respectively, a relational expression P3j·VTF(f3j)≦0.015 is satisfied by each of four combinations of three colors selected from the four colors.
